(19) United States
(12) Patent Application Publication
(10) Pub. No.: US 2013/0054297 A1
(43) Pub. Date: Feb. 28, 2013

(54) SYSTEM AND METHOD FOR ORDERING ARTWORK

(71) Applicant: Sébastien GAGNON, Quebec (CA)

(72) Inventor: Sébastien GAGNON, Quebec (CA)

(21) Appl. No.: 13/601,453

(22) Filed: Aug. 31, 2012

Related U.S. Application Data
(60) Provisional application No. 61/529,441, filed on Aug. 31, 2011.

(51) Int. Cl. G06Q 30/06; G06Q 10/06

(52) U.S. Cl. 705/7.25; 705/26.8

(57) ABSTRACT

A method for producing an order for artwork, comprising: retrieving a list of producers, the list of producers including a producer identification and at least one style identification for each producer identification; retrieving availability data for the producers; receiving a request for artwork from a requester, the request including a requested style identifier and a performance condition; identifying an available skilled producer among the list of producers, by comparing the performance condition to the availability data and comparing the requested style identifier to the style identification, the at least one style identification of the available skilled producer including the requested style identifier and the availability data of the available skilled producer meeting the performance condition; generating an order request for artwork to the available skilled producer.

### REFERENCE TO RELATED APPLICATIONS

This application is the first application filed for the present invention.

### TECHNICAL FIELD

The present invention relates to a system and a method for ordering artwork, and more particularly to a computerized system making it possible to standardize the preparation of artwork orders.

### PRIOR ART

A requester may ask for the production of an illustration in a style specific to a producer who is no longer available, and which a new producer does not know how to reproduce.

There is therefore a need for a standardized formalization of illustrative styles. They may thus be compromised, compared and manipulated by different producers.

Producers who generate artwork must obtain as much information from their requester as possible relative to the artwork to be produced so as to fulfill the requester's order. It is often difficult for the requester to define his taste, needs, and performance criteria. For the producer, it is difficult to assess the amount of work to be done, and therefore to set a price and a turnaround time for the order.

There is therefore a need to standardize artwork orders.

One producer is often frequently unable to generate an illustration alone, in whole or in part, due to a lack of time or skill. He may be frustrated by the great difficulty in effectively and quickly collaborating with other producers, given the lack of standardized vocabulary and processes in the industry.

There is therefore a need for a framework to improve the exchange of skills, sharing of tasks, and dynamic cooperation, to have a more regular workload and more consistent work quality from producers and co-producers.

Requesters also often ask the producer to use a style whereof the features are obtained by a mix of various elements from disparate sources. However, quite often, the producer does not know how to arrange and depict all of those elements.

There is therefore a need to create an original style through a customized assembly.

### SUMMARY

This system concerns the identification, analysis/decoding, classification, and/or production of the elements making up an illustration.

According to one broad aspect of the present invention, there is provided a method for producing an order for artwork, the method comprising: retrieving a list of producers, said list of producers including a producer identification and at least one style identification for each producer identification; retrieving availability data for said producers; receiving a request for artwork from a requester, the request including a requested style identifier and a performance condition; identifying an available skilled producer among said list of producers, by comparing the performance condition to said availability data and comparing the requested style identifier to the style identification, said at least one style identification of said available skilled producer including said requested style identifier and said availability data of said available skilled producer meeting said performance condition; generating an order request for artwork to the available skilled producer.

In one embodiment, the method further comprises retrieving a cost per production unit for said requested style identifier; receiving an estimation of a number of production units required for the order request, said estimation being prepared using the performance condition; generating a cost submission for the order request by multiplying the number of production units by the cost per production unit.

In one embodiment, the method further comprises retrieving a production time per production unit for said requested style identifier; receiving an estimation of a number of production units required for the order request, said estimation being prepared using the performance condition; generating a time submission for the order request by multiplying the number of production units by the time per production unit.

In one embodiment, the method further comprises determining a multiplying factor using said performance condition and wherein said generating said time submission includes multiplying said multiplying factor by the number of production units and by the time per production unit.

In one embodiment, the method further comprises determining a multiplying factor using said performance condition and wherein said generating said cost submission includes multiplying said multiplying factor by the number of production units and by the cost per production unit.

In one embodiment, the method further comprises receiving a quotation for said request, said quotation including a description of a subject to be produced connected to the request; and assigning said quotation to said order request.

In one embodiment, the style identification includes at least one independent style element identification, said style element identification representing a style element being chosen from among shape, line, texture, color.

In one embodiment, the method further comprises retrieving a plurality of models, each model for a single one of said style identification, said model depicting the style represented by said style identification, the model being artwork produced from a shared generic documentary reference and being a print of the style; Displaying said models; Receiving an indication of a chosen model among said models; and Extracting the style identification corresponding to the chosen model.

In one embodiment, the method further comprises retrieving a list of possible styles, said list of possible styles including said style identification and at least one indexed style parameter for each of said styles; receiving a desired style parameter; identifying, among the styles of said list of possible styles, a style for which the desired style parameter corresponds to an indexed style parameter; Extracting the style identification corresponding to the identified style of the desired parameter; wherein said indexed style parameter is chosen from among the following types of parameters: type of targeted illustrated function, level of realism/proportionality of a style, type of transformation at a root of a level of realism/proportionality of a style, style number, a matrix code, such as QR code, barcode, 2D matrix code, micro QR code, promotional code, price modifier related to a style, form of depiction, family of a style, primary gesture indicator, gesture family, level of compatibility of gestures, genre/sub-genre of a style, production rule, gesture genre/sub-genre, novelty of a style, graphic property, chromatic property such as genre/sub-genre of coloring/palette, depiction parameters related to a subject to be illustrated, relational property, perceptual value evoked, perceptual value related to a style and emotion evoked, with a polarity and intensity value, ambiences evoked, geographic origins evoked, cultural origins evoked, historical origins evoked, artistic movements evoked, artists, artist-specific styles, level of credibility/reputation of a producer/co-producer, affiliation of a producer/co-producer, history of a producer/co-producer, status of a producer/co-producer, resources of a producer/co-producer, area of expertise/experience of a producer/co-producer, quality of a producer/co-producer, determined by: level of punctuality, speed of delivery, efficiency, satisfaction, versatility, information related to collaboration possibilities, professional sector, applied art professional sector, associated technique, associated medium, preference related to a activity sector of a recipient, behavioral model of a target audience, gender of a target audience, socioeconomic profile of a target audience, geographic origin of a target audience, culture or subculture of a target audience, age group of a target audience, type of copyright management for a style, search and order history for a style, identifier for a requester, search and order history for a requester, identifier for a group of a requester, search and order history related to a group of a requester, identifier of a recipient, search and order history for a recipient, identifier of a target audience, search and order history for a target audience, short-term popularity, long-term popularity, short-term appreciation, long-term appreciation, short-term satisfaction level, long-term satisfaction level, quantity of elements of a same module that can be reproduced by a same producer, availability of elements of a same module that can be reproduced by a same producer, quantity of elements of a same module that can be reproduced by different producers, availability of elements of a same module that can be reproduced by different producers, production time, delivery date, anticipated budget, origin of a writer, difficulty coefficient, quantity, availability of a qualified producer/co-producer, origin of a producer/co-producer, region of residence of a producer/co-producer, currency used by a producer/co-producer, cost of living by region, value of a currency, contribution value, type of copyright management for a producer, level of exclusivity required for a image to be produced.

In one embodiment, the performance condition includes at least one performance data among the following: production time, partial delivery date, final delivery date, anticipated budget, level of detail, type of outline, exclusivity level required for the image that will be produced, for at least one of the producer, co-producer, and production team, experience, skill level, performance, knowledge level by subject, punctuality, history, origin, language, region, rate level of the region, time zone of the region, value of the contribution, responsibility level, type of copyright management.

In one embodiment, the method further comprises verifying that production rights of the request are appropriate using a list of appropriate production rights.

In one embodiment, the artwork is at least part of a piece of artwork.

In one embodiment, the style elements are assembled to create a personalized style.

In one embodiment, the method further comprises saving a search history for a requester in the list of styles; using the history to provide search results to the requester in a subsequent search.

In one embodiment, the request includes a usage condition for the artwork; the method further comprising obtaining usage permission data for said producer; in which the step for identifying an available skilled producer also includes a producer for whom the usage condition corresponds to the permission data.

According to another general aspect of the invention, a method for ordering artwork is described. This method includes obtaining a list of producers, each producer being capable of generating artwork in at least one style; obtaining a list of styles; obtaining availability data for each producer; obtaining a request for artwork from a requester, the request including a style identifier and a performance condition; identifying an available skilled producer among the list of producers, by comparing the performance condition to be availability data and comparing the style identifier to the style to identify a producer whose style corresponds to the style identifier, and comparing the corresponding availability data to the performance condition; generating an order for artwork and sending that order to the available skilled producer.

In one example embodiment, the list of styles including a cost per production unit required to produce artwork in each style, the method further comprising extracting the cost per production unit required for the style identified by the style identifier from the list of styles; estimating a number of production units required for the request from the performance condition; generating a submission for the request by multiplying the number of production units by the cost per production unit; and sending the submission to the party making the request.

In one example embodiment, the list of styles includes a production time per production unit required to produce artwork in each style, the method further comprising extracting the time per production unit required for the style identified by the style identifier from the list of styles; estimating a number of production units required for the request from the performance condition; generating a submission for the request by multiplying the number of production units by the time per production unit; and sending the submission to the party making the request.

In one example embodiment, the step for generating a submission also includes multiplying the number of production units by a multiplier related to a performance condition. In one example embodiment, the method also includes obtaining the quotation for the request, the quotation including a description of a subject to be produced connected to the request, and attaching the quotation to the order.

In one example embodiment, the style includes at least one style element, each style element being able to be identified independently, each style element being chosen from among the shape, line, texture, color.

In one example embodiment, the method also includes obtaining a model for each style or style element depicting the style, the model being artwork produced from a shared generic documentary reference and being a print of the style, each model being indexed with the style identifier corresponding to the illustrated style; showing at least one of the models to the requester; receiving an indication of the model chosen by the requester; and extracting the style identifier corresponding to the chosen model; and the step for obtaining a request involving including the style identifier with the request.

In one example embodiment, obtaining a list of styles includes obtaining a style parameter indexed for each style in the list of styles, the style parameter being chosen from various types of parameters. The type of targeted illustrated function, such as consultation, comprehension, affiliation, sensation, inspiration, is one example. The level of realism/proportionality of the style, type of transformation at the root of the level of realism/proportionality of the style is also part of the list. These transformations include addition, deletion, substitution, exchange. They may be linked by identity, similarity, opposition, difference. The list may also include the style number as well as a matrix code, such as QR code, barcode, 2D matrix code, micro QR code, or another matrix code linked to the style. The list further includes any promotional code or price modifier related to the style, form of depiction, family of the style, primary gesture indicator, gesture family, level of compatibility of gestures, genre/sub-genre of the style, production rule, gesture genre/sub-genre, novelty of the style, graphic property, chromatic property such as genre/sub-genre of coloring/palette such as intimate, colorist, luminist. Examples also include depiction parameters related to the subject to be illustrated, relational property, perceptual value evoked, perceptual value related to the style and emotion evoked, with a polarity and intensity value. It should also be noted that the polarity and the intensity of any emotion or impression may be distributed over a dial, in at least four zones. These zones are identified as negative/strong, negative/weak, positive/strong, positive/weak. Furthermore, the properties/categories of emerging property may appear on the list. An emerging property is the result of the twinning of various elements, according to various contexts, ambiences evoked, geographic origins evoked, cultural origins evoked, historical origins evoked, artistic movements evoked, artists, artist-specific styles, level of credibility/reputation of the producer/co-producer, affiliation of the producer/co-producer, history of the producer/co-producer, status of the producer/co-producer, resources of the producer/co-producer, area of expertise/experience of the producer/co-producer, quality of the producer/co-producer, determined by: level of punctuality, speed of delivery, efficiency, satisfaction, versatility, etc. Other information may be included on the list, such as information related to collaboration possibilities, professional sector, applied art professional sector, associated technique, associated medium, preference related to the activity sector of the recipient, behavioral model of the target audience, gender of the target audience, socioeconomic profile of the target audience, geographic origin of the target audience, culture or subculture of the target audience, age group of the target audience, type of copyright management for the style, search and order history for the style, identifier for the requester, search and order history for the requester, identifier for the group of the requester, search and order history related to the group of the requester, identifier of the recipient, search and order history for the recipient, identifier of the target audience, search and order history for the target audience, short-term popularity, long-term popularity, short-term appreciation, long-term appreciation, short-term satisfaction level, long-term satisfaction level, quantity of elements of a same module that can be reproduced by the same producer, availability of elements of a same module that can be reproduced by the same producer, quantity of elements of a same module that can be reproduced by different producers, availability of elements of a same module that can be reproduced by different producers, production time, delivery date, anticipated budget, origin of the writer, difficulty coefficient, quantity, availability of the qualified producer/co-producer, origin of the producer/co-producer, region of residence of the producer/co-producer, currency used by the producer/co-producer, cost of living by region, value of a currency, contribution value, type of copyright management for the producer, level of exclusivity required for the image to be produced; the method further comprising: receiving a desired style parameter from the requester; identifying, among the styles, a style for which the indexed style parameter corresponds to the desired style parameter; extracting the style identifier corresponding to the style of the desired parameter; the step for obtaining a request involving including the style identifier with the request.

In one example embodiment, the performance condition includes at least one piece of information among the following: production time, partial delivery date, final delivery date, anticipated budget, level of detail, type of outline, exclusivity level required for the image that will be produced, for at least one of the producer, co-producer, and production team, experience, skill level, performance, knowledge level by subject, punctuality, history, origin, language, region, rate level of the region, time zone of the region, value of the contribution, responsibility level, type of copyright management.

In one example embodiment, the method also includes verifying that the production rights of the request are appropriate.

In one example embodiment, the artwork is at least part of a piece of artwork.

In one example embodiment, the method also includes assembling style elements to create a style.

In one example embodiment, the method also includes saving a search history for a requester in the list of styles; using the history to provide search results to the requester.

In one example embodiment, the request includes a usage condition for the artwork; the method further comprising obtaining usage permission data for each producer; in which the step for identifying an available skilled producer also includes a producer for whom the style corresponds to the style identifier, the availability data corresponds to the performance condition, and the usage condition corresponds to the permission data.

### DEFINITIONS

In order to allow a better understanding of the present description relative to the drawings, the following definitions are proposed:

Image: depiction of one or more subjects by drawing, painting, sculpting, etching, photo, video, or any other visual expression medium.

Artwork: two-dimensional image, which is not a photo, and intended to accompany, reinforce, decorate, explain, support, make understood, etc. an idea, in a work.

Producer: one who generates one or more pieces of artwork.

Requester: any entity submitting a request to order artwork or capable of doing so.

Receiver: one who receives a signal, a message, conveyed by an image, which the interprets.

Object: unit, part of a set of knowledge. This is a group of data, information recorded, exchanged, combined, transformed, etc. during a process.

Graphic object: class of objects depicting a subject or a concept in artwork.

Subject: real thing to which a graphic object refers in artwork.

Illustrative style: set of rules, procedures, techniques, etc. serving to interpret, transform a subject to create a depiction thereof. This may also simply be designated by the term “style.” The style may also describe the way of making, the gesture allowing that depiction, sometimes obtained by dexterity.

Dexterity: skill resulting from know-how, which is transmitted by demonstration.

Style element: reference unit in the creation of an illustrative style. This is the smallest indivisible fraction of an illustrative style module. It may also be designated by the term “element.” Each element embodies one of the four dimensions defining, making up artwork: shape, line, texture, color.

Style module: group generally made up of 2 to 8 elements. A minimum of two and a maximum of four per plane to be illustrated. This may also be designated by the term “module.”

Depth plane: group of graphic objects occupying the same space during the two-dimensional simulation of the third dimension, i.e. the depth. Artwork usually consists of two planes: the foreground, showing the main subject(s), and the background, showing one or more secondary subjects, such as decor elements, or a landscape.

Style plane: group of objects that share the same style (element or module) and that can occupy the same depth plane or share it with other groups of objects.

Reference image: non-generic graphic object, previously indexed and identified as belonging to a given producer and bearing an original style, which has been reproduced on a model to which it is connected.

Generic documentary reference: graphic object used as a model to produce one or more reference images. It may also be designated by the term “generic image.”

Model: artwork produced by a producer from a shared generic documentary reference, i.e. a same photograph used as example, print of the same style as the reference image to which it is connected.

Indexing: process consisting of assigning an object the subject it addresses or depicts, in a database.

Metadata: data serving to define or describe other data, irrespective of its medium.

Parameter: piece of information taken into account to make a decision, perform a calculation.

Static data: fixed, immutable information, referring to the intrinsic characteristics of an object.

Static property: parameter with fixed, immutable values, defining the intrinsic characteristics of an object.

Dynamic data: information having a variable, circumstantial and evolving value. This value may be influenced by outside parameters.

Dynamic property: parameter with variable, circumstantial and cumulative values, defining the characteristics of an object.

Perceptual value: dynamic property, defining a style by providing information about the perceptions it generates with a receiver.

Tacit perceptual value: that which is experienced personally, which is not shared through references. For example, the atmospheres or emotions felt.

Shared perceptual value: that which is reflected, formalized and shared by means of shared references. These references may be cultural, historical, sectorial, etc.

Identifier: data making it possible to recognize, classify the object to which it is indexed. This may be a number, a title, an alphanumeric code, a 2D barcode or matrix, etc.

Difficulty coefficient: parameter providing information on the difficulty level associated with the reproduction of a style. It takes into account the quantity, the variability of the actions required to reproduce it.

Production unit: the smallest fraction used to quantify, measure the anticipated workload to produce artwork.

Nature: category, class, family to which an object belongs. For example, the nature of an element tells us whether it embodies, defines a shape, line, or texture style, or a color treatment.

Qualification: attribution or acquisition of the skill(s) necessary to perform a professional activity. This may for example involve carrying out, reproducing a style.

Style family: large division within the elements class, as objects.

Gesture family: group of gesture profiles whereof the key parameters are of similar intensity and corresponding to a same behavior, particular outline.

Style genre/sub-genre: subdivision of a style family,

Gesture genre/sub-genre: subdivision of a gesture family,

Average value analysis: classification process consisting of measuring the average value and the value intervals associated with each of the static properties defining an element. Then, they are compared to those of each style family to classify the style in the appropriate family or families.

Cumulative value analysis: average value analysis applied to a complete module, for which a cumulative average will be assigned, taking all of the elements making it up into account.

Graphic property: static property defining the visual characteristics of the style.

Realism: graphic property that refers to the level of faithfulness, the appearance given to a graphic object by an element, relative to the actual subject. It does not, however, take proportions into account. The style being a filter that more or less modifies a subject, this parameter will classify it as analogical if it reproduces reality very faithfully, or arbitrary if it distorts reality greatly.

Proportionality: graphic property that reflects the level of faithfulness, the appearance given to a graphic object by an element, in relation to the real subject, by measuring compliance with its proportions. It compares the parts of a graphic object to the subject in its entirety, through a part-whole analysis. This analysis occurs upon each modification, addition or removal of a part. The proportionality will be classified as balanced or imbalanced.

Type of gesture: graphic property referring to eight parameters, i.e. four gesture parameters, two state parameters and two outline parameters, defining, from a graphic perspective, the act at the root of the expression of a style. These parameters are: orientation, fluidity, amplitude, direction, density, intensity, constancy, and demarcation.

State parameter: qualifies the gesture by the state of mind which supports the gesture.

Gesture parameter: qualifies the gesture by the movement initiating the elementary outline,

Outline parameter: qualifies the gesture through the outline built, resulting from the movement.

Orientation: gesture parameter qualifying the gesture as being more rounded or more angular, by also comparing it to that evoked in the generic image.

Fluidity: gesture parameter qualifying the gesture as being more fluid or more rough, by also comparing it to that evoked in the generic image.

Amplitude: gesture parameter qualifying the gesture as being shorter or longer, by also comparing it to that evoked in the generic image.

Direction: gesture parameter qualifying the gesture as being more controlled or freer, by also comparing it to that evoked in the generic image.

Density: outline parameter qualifying the gesture as being simpler, more sparse or more complex, dense, by also comparing it to that evoked in the generic image.

Intensity: state parameter qualifying the gesture as being weaker, more subtle or stronger, more pronounced.

Constancy: state parameter qualifying the gesture as being more regular or more irregular, by also comparing it to that evoked in the generic image.

Demarcation: outline parameter qualifying the gesture as being sharper or more vague, by also comparing it to that evoked in the generic image.

Chromatic property: static, independent property, not defining the colors as such, but the type of harmony making them interact and the characteristics related to their treatment.

Relational property: static property related to a shape, line and texture element that defines the relationship each one maintains with each of the other two. There are three: concordance, alignment and integration.

Concordance: relational property that determines how one element occupies the space to create its effect, when it interacts with the other elements: should it be more concordant or discordant? The space occupied by a concordant element will respect the boundaries, will imitate the path and sometimes the gesture of the element to which it is related. If it is qualified as being discordant, it does not respect the boundaries, path, or sometimes the gesture of the element with which it is related.

Alignment: relational property that determines how one element occupies the space to create its effect, when it interacts with the other elements: should it be more aligned or offset? An aligned element will fit the boundaries while being juxtaposed with the element to which it is related. If it is qualified as being offset, this means that it will not fit the boundaries, path, or sometimes the gesture of the element with which it is related. It may be more or less offset in any direction.

Integration: relational property that determines how an element occupies the space, to create its effect, when it interacts with the other elements: should it be more integrated or separated? An integrated element will meld, mix with the element to which it is related. If it is qualified as being separate, that means it will not mix or meld with the element to which it is related.

DBS: database system.

DB: database.

Request identifier: identifier referring to an earlier request operation.

File identifier: identifier referring to a submission or a quotation previously generated, as well as any operation having been performed in relation thereto. This may involve an addition, removal, or transformation.

Submission: written document in which a commitment, a job to be performed, and the price are defined, usually in compliance with specifications or guidelines.

Division identifier: identifier referring to an operation for the division of an earlier module.

Assembly identifier: identifier referring to an assembly operation for an earlier module.

Description identifier: identifier referring to an earlier description operation.

Lighten: subtract one or more elements from a module and reassemble the remaining elements without adding new ones.

Writer: entity that records a style.

Document: record, store the actions necessary to generate a model. Store the reproduction of each object and element by screen casting.

Generate a style: apply, reproduce a style so as to find the depiction, the effects thereof from a generic documentary reference, through the following actions: sketch, draw, surface, coloration.

Sketch: outline the main shapes of a graphic object: define its boundaries and orientations.

Draw: shape, form the main lines of the graphic object in their final appearance. This usually involves lines suggested by the main contours and visible features.

Surface: fill in the surface of a graphic object, usually by integrating one or more textures.

Color: apply one or more colors on one or more lines, textures, surfaces of a graphic object.

Style-generating software: graphic production software compatible with the style generation process.

Native format: standard file format with encoding specific to the image processing software used. Examples of suffixes referring to native formats include: .psd, .ai, etc.

Inherited format: open file format, with encoding type recognized by several image processing software applications. Examples of suffixes referring to inherited formats include: .jpg, .png, etc.

Proposal: search result obtained following a request.

High resolution: in digital imaging, refers to the concentration of a large number of dots, pixels to cover a given distance. This density will be at least 300 dots per inch.

Low resolution: in digital imaging, refers to the concentration of a low quantity of dots, pixels to cover a given distance. This density will be 72 dots per inch.

Full save: saving the model in the native format, at high resolution, and identified by its corresponding file number.

Save by element: saving each graphic object corresponding to a subject of the model, in an inherited format, in high resolution and low resolution.

Style formula: list of all of the actions and objects necessary to produce a style element. It also includes an exhaustive list of the necessary procedures. It usually includes a reference image and short video capsules outlining these actions, explicitly, using a standardized syntax.

Social media: electronic networks using highly accessible communication techniques to facilitate social interactions.

Nature of a subject: provides information on the genre/sub-genre of the subject as object, i.e. whether it involves a person, a simple or elaborate graphic object, etc.

Skill: recognized ability in a field, in particular the visual communication field, to complete a given task or set of tasks.

Performance: degree of accomplishment of a given task or set of tasks, measured by comparison to predefined standards, concerning a parameter. This may involve parameters such as accuracy, completeness, performance time, etc. Performance is measured independently of experience or training.

Producer history: ledger containing data referring to the actions performed by a producer. This may involve information regarding the producer's knowledge, skills, experience, performance, etc. It may also be related to other files, illustrative styles, requesters, different contexts, any disputes, etc.

Responsibility level: measure of the number of tasks, actions, related to the style elements making up a same module, which may or must be performed by a same producer.

Contribution value: measure of the estimated impact, positive or negative, the contribution had, has, or will have on other related contributions or activities. The contribution value may refer to the cumulative value of all of the contributions coming from an entity.

Recipient: any entity for which artwork provides a direct value added, and which uses it for commercial or communication purposes.

Target audience: receiver for whom the message conveyed by artwork is specifically intended. That which is targeted by the commercial or communication-based use of the artwork.

Semiotic effect: phenomenon revealing how a recipient's look participates in a graphic object and how the latter interprets it. It reveals the logic the recipient obeys. The phenomenon mentioned here does not pertain to icons: the graphic object that refers to the subject. It is related to the style used to depict it, which has a meaning with its types of depiction, which are the shape, the line, the texture, and the color.

Visual style figure: expression method that moves away from the ordinary usage of graphic language. It gives a particular expressiveness to the depiction. Allegory, metonymy, paradox, hyperbole, etc. are common visual style figures. The style figure described here does not pertain to the intention related to the subject-matter of the graphic object as such, but that inherent to the style used to depict it. It also pertains to its relationship with reality and other styles that may be compared.

Primary gesture indicator: informing about the most critical parameter(s) involved in the uniqueness of a given gesture. This is the dominant feature of the act.

Heat map: Color-guided representation, informing about the number of clicks on various parts of an interface. Traditionally used in web usability, a heat map is here exploited on different interfaces, from image generation software, for example. It provides information on their use, guessing functions used at a given time.

### BRIEF DESCRIPTION OF THE FIGURES

Having generally described the nature of the invention, reference will now be made to the drawings accompanying the application, showing one example embodiment of the invention and in which:

FIG. 1 is a block diagram illustrating main components of an example system for the recordal;

FIG. 2 is a block diagram illustrating main components of an example system for the order;

FIG. 3 is a flowchart illustrating main steps of an example recordal method;

FIG. 4 is a flowchart illustrating main steps of an example ordering method;

FIG. 5 includes FIG. 5a, FIG. 5b, FIG. 5c, FIG. 5d, FIG. 5e and FIG. 6f in which FIG. 5a illustrates a generic documentary reference, FIG. 5b illustrates a model showing a realistic style, FIG. 5c illustrates a model showing a fantastical style, FIG. 5d illustrates a model showing an etched style, FIG. 5e illustrates a model showing a watercolor style and FIG. 5f illustrates a model showing a comic strip style;

FIG. 6 illustrates graphic objects for producing a model;

FIG. 7 includes FIG. 7a and FIG. 7b in which FIG. 7a illustrates an example of a full save and FIG. 7b illustrates an example of a save by element;

FIG. 8 includes FIG. 8a, FIG. 8b, FIG. 8c, FIG. 8d, FIG. 8e, FIG. 8f, FIG. 8g, FIG. 8h, FIG. 8i, FIG. 8j, FIG. 8k, FIG. 8l, FIG. 8m in which FIG. 8a illustrates the levels of respect for reality: the realism, FIG. 8b illustrates the levels of orientation defining the gesture, FIG. 8c illustrates the levels of fluidity defining the gesture, FIG. 8d illustrates the amplitude levels defining the gesture, FIG. 8e illustrates the direction levels defining the gesture, FIG. 8f illustrates the density levels defining the gesture, FIG. 8g illustrates the intensity levels defining the gesture, FIG. 8h illustrates the constancy levels defining the gesture, FIG. 8i illustrates the demarcation levels defining the gesture, FIG. 8j illustrates the levels of respect for proportions: the proportionality, FIG. 8k illustrates the concordance levels defining the inter-element relationships, FIG. 8l illustrates the alignment levels defining the inter-element relationships, FIG. 8m illustrates the integration levels defining the inter-element relationships;

FIG. 9 includes FIG. 9a and FIG. 9b in which FIG. 9a illustrates the front of an example style card and FIG. 9b illustrates the back of the style card;

FIG. 10 includes FIG. 10a, FIG. 10b, FIG. 10c, FIG. 10d, FIG. 10e, FIG. 10f, FIG. 10g, FIG. 10h in which

FIG. 10a illustrates the structure forming the front of a multi-selection carousel, FIG. 10b illustrates the structure forming the back of a multi-selection carousel, FIG. 10c illustrates a detailed front view of the multi-selection carousel, FIG. 10d illustrates a detailed back view of the multi-selection carousel, FIG. 10e illustrates a detailed front view of the color dial, FIG. 10f illustrates a detailed front view of the shape dial, FIG. 10g illustrates a detailed front view of the line dial, FIG. 10h illustrates a detailed front view of the texture dial;

FIG. 11 illustrates the structure of a style table;

FIG. 12 includes FIG. 12a and FIG. 12b in which FIG. 12a illustrates the molecular depiction structure of a style and FIG. 12b illustrates the molecular depiction of a style; and

FIG. 13 illustrates a graphical representation of an overview of the components of the model.

### DETAILED DESCRIPTION OF THE INVENTION

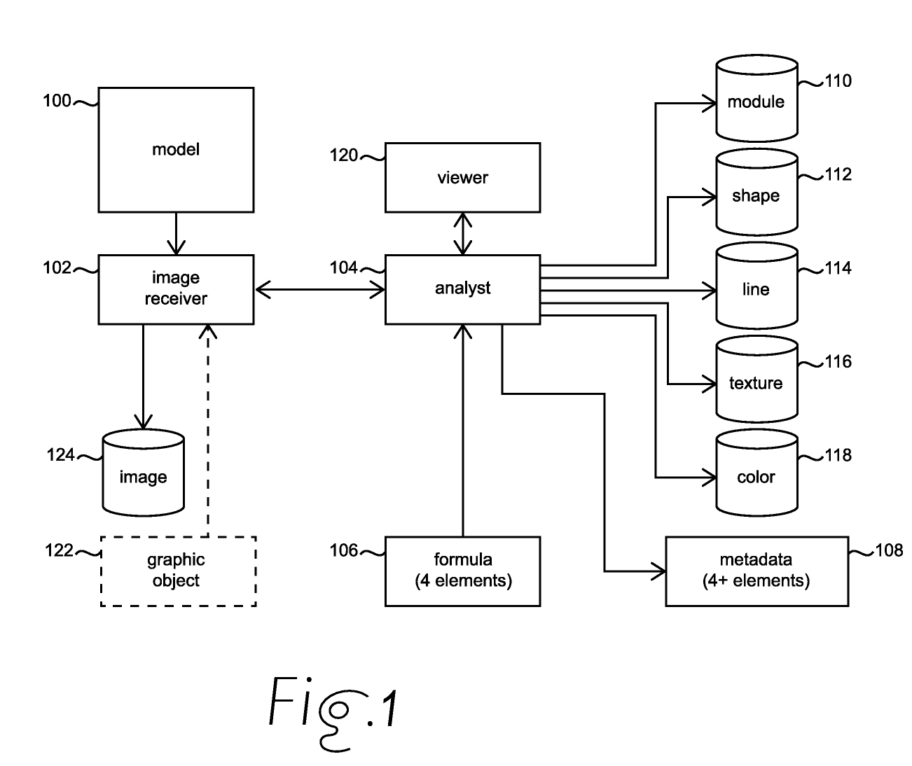

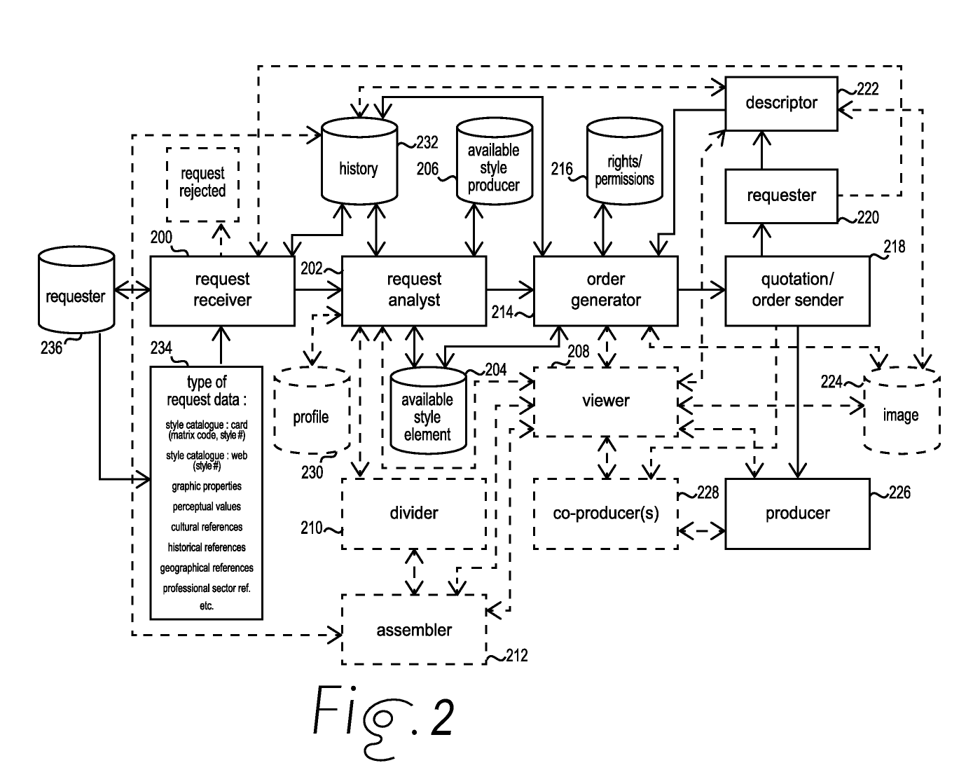

FIG. 1: Block Diagram Illustrating the Recordal

Models 100 have been generated and identified by the producer. Each model 100 shows the visual effect produced by an illustrative style element.

The models 100 are sent to the image receiver 102, which receives and redirects the elements and graphic objects 122 depending on whether they have been processed, rejected, or directly stored in a database.

To be declared compliant by the image receiver 102, any graphic object 122 that is not a model must be saved in a file in the inherited format, and must be named, then identified by an existing model generation file number. If a graphic object is named, then identified by an existing model generation file number, but it is saved in a file in the native format of an image-generating software application, in layers, it will be identified as a model: noncompliant, but capable of being processed.

The noncompliant elements and graphic objects 122 that cannot be processed are therefore rejected. Those that are not compliant and can be processed are sent to the analyst 104, and the compliant graphic objects 122 are placed in the image warehouse 124.

A graphic object 122 is considered compliant if it: bears the same identifier as the models transmitted at the same time, is indexed to any element whereof it allows the reproduction. Each compliant element is directed to the corresponding database: shape 112, line 114, texture 116, or color 118, which connects it to others, if it is part of one or more modules. These connections are recorded in the module database 110.

For the model 100 to be able to be transferred and processed by the analyst 104, the metadata 108, made up of statistical data, must be indexed therein beforehand.

This metadata relates to the skills and resources necessary to reproduce each element. These resources are often technical, such as, for example, a file or software application having made it possible to reproduce the style, its version, language. They may also refer to the time and cost to carry out a style, per production unit and difficulty coefficient. The identification for its producer, its reference image, and its nature are also found therein, as well as the associated style module(s), the conditions, usage rights and guidelines. This includes the various authorized licenses/licenses that can be assigned (copyrights).

The permissions and restrictions it comprises are added to this list. They provide information on the type of usage allowed for the style they represent: private, i.e. not authorized for reproduction by all producers, or public, i.e. authorized for reproduction by all qualified producers.

Furthermore, perceptual values, each of which is identified from a list using standardized vocabulary, will have been indexed therein. These may be tacit perceptual values of an emotional nature, such as the atmosphere, or of a cultural nature, related to the lifestyle, cultural setting, etc. These may also be shared perceptual values, using formal references. These may for example be regional, historical references related to an artistic movement or an artist, a professional sector, an artisanal technique, a medium, etc.

Lastly, for an element to be compliant, the analyst 104 first isolates it from the model 100 by identifying the parameters characterizing it. The analyst 104 will index a measurable value, the result of a visual analysis that will have been provided to it, to these parameters, or static properties. For example, a number from 0 to 9 may be associated with each of these static properties, so as to assign them an intensity. Among these, there are first three graphic properties.

First, realism, which refers to the level of faithfulness, the appearance given by an element, relative to the real subject. It does not, however, take proportions into account. The style being a filter that more or less modifies a subject, this parameter will classify it as analogical, if it reproduces reality very faithfully, or arbitrary, if it distorts reality greatly.

Secondly, proportionality, which reflects the level of faithfulness, the appearance given by an element, relative to the real subject, by measuring the compliance of its proportions. It compares the parts of a graphic object 122 to the subject in its entirety, through a part-whole analysis. This analysis takes place upon each modification, addition, or removal of a part. The proportionality will be classified as balanced or unbalanced.

Third, the gesture, which refers to eight parameters. For each of these parameters, one qualifier will first be assigned describing an intensity level, followed by another qualifier describing its opposite.

First, orientation: from rounded to angular;

Second, fluidity: from fluid to rough;

Third, amplitude: from short to long;

Fourth, direction: from controlled to free;

Fifth, density: from sparse to dense;

Sixth, intensity: from low to high;

Seventh, constancy: from regular to irregular;

Eighth, demarcation: from sharp to vague.

Additionally, there are three relational properties. These three parameters will qualify three combinations of elements, i.e. shape and line, shape and texture, and line and texture. For each of these, the qualifier describing its lowest intensity will first be described, followed by the qualifier describing its highest intensity. First, the concordance level, i.e. from concordant to discordant. Next, the alignment level, i.e. from adjusted to offset. Then, the integration level, i.e. from integrated to separate.

Furthermore, chromatic properties, initially associated with the element, will be connected thereto. They do not define the colors of the element as such, but the type of harmony that causes the colors to interact. For example, this may be a harmony of complementary, primary, secondary, warm, cold, or pastel colors, tonality, saturation, contrast, brightness, etc.

Lastly, the analyst 104 will associate the model 100 with one or more families, and, if applicable, with one or more genres/sub-genres. This association will be done by level of similarity with the processed style, regarding the values of its graphic, chromatic and relational properties. This classification will be done through an average value analysis. This will instead be a cumulative value analysis if it is done for a module.

The analyst 104 also receives the formula 106, which indexes to the element. The formula 106 is made up of the exhaustive list of the steps, actions necessary to reproduce the element. It typically includes a reference image and short video capsules explicitly outlining those actions using a standardized syntax.

The viewer 120 makes it possible to show any graphic object 122 for consultation purposes.

FIG. 2: Block Diagram Illustrating the Order

The request receiver 200 receives and redirects the requests. They will either be rejected, if they are not compliant, or sent to the request analyst 202 to be processed, if they are compliant.

To be declared compliant by the request receiver 200, a request 234 must always be associated with a requester 220, previously identified and stored in the requester database system 236 (DBS). The requester 236 must possess the ordering rights (not shown). In this regard, databases containing businesses' public information are connected to the system in real-time. This information, like the activity sector operational status (deleted, questioned, complaints, etc.), is produced by various entities, such as the Quebec business register. The request must also contain complete information. This information comes from lists of terms preapproved or recognized by the request receiver 200. It is associated with each parameter, i.e. production times and dates, anticipated delivery dates and budget, as well as data painting a picture of the required producer(s) 226, i.e. experience, skills, performance, origin, region or time zone, etc. A request must therefore contain data and refer to axioms recognized by the request receiver 200.

In fact, a request may be made using various axioms, each reflecting a point of view making it possible to classify or look for a style. This may therefore be done taking into account: style family, style genre/sub-genre, style novelty, graphic property, chromatic property, relational property, perceptual value evoked, emotion evoked, atmosphere evoked, geographic origin evoked, cultural origin evoked, historical origin evoked, artistic movement evoked, artist, artist-specific style, professional sector, applied art professional sector, associated technique, associated medium, preference related to the activity sector of the recipient, behavioral model of the target audience, socioeconomic profile of the target audience, geographic origin of the target audience, culture or subculture of the target audience, age group of the target audience, type of copyright management for the style, search and order history for the style, requester, recipient, target audience, short- and long-term popularity, short- and long-term appreciation, short- and long-term satisfaction level, quantity and availability of an element of a same module that may be reproduced by the same producer, quantity and availability of an element of a same module that may be reproduced by different producers, production time, delivery date, anticipated budget, origin of the writer, difficulty coefficient, quantity and availability of qualified producers, region of residence of the qualified producer, type of copyright management for the producer, level of exclusivity required for the image to be produced, etc. The request may also be made directly by entering an identifier from an online or printed catalog, by style number, QR code, 2D barcode of the style, or other codification.

The request receiver 200 associates any request with its requester 220, using a request identifier. Furthermore, if, in this indexing process, the request receiver 200 notes a file identifier, the informant and the order have already gone through this step of the process, and it will attach this new request identifier to that of the existing file. This recordal will be done in the history DBS 232. It is also possible to query the history DBS 232 and the profile DBS 230 to find request-profile correlations that will be indexed to the request. This will allow the request analyst 202 to propose results to the requester, taking this data into account.

It may also query a DBS dedicated to style/gesture families or production teams to find the compatible objects (not shown). It may also query a DBS dedicated to semiotic effects caused by the assemblies and the relationships/connections maintained between the elements making them up (not shown). This DBS also organizes the elements in a hierarchy by measuring the intensity of the effect of an element, compared to the other associated elements. The visual style figures follow one of these four comparative mechanisms, i.e. identity, similarity, opposition, and difference. Another DBS (not shown) regarding the level of stylization of an element can also be queried. This DBS examines the effect resulting from the depiction of a same subject by that element, by comparing it to a model. This involves the most faithful depiction of the subject possible, or reality. The level of stylization, characterized by the remoteness from reality and determined by the realism and proportionality, is caused by 3 types of graphic transformation: addition, elimination, substitution. Another DBS (not shown) may consider the patterns emerging from previous requests. This DBS could use the data from the history DBS 232, among others. For example, the semiotic effects or the visual style figures resulting from assemblies from a same requester could be extracted.

Lastly, several other DBSs may participate in this query process, i.e. image, profile/status of the requester, profile/status of various segments, evaluation/reputation of requesters/producers/co-producers, results of trend analysis.

The DBS of trend analysis results may use data generated, inter alio, by the real-time examination of all of the databases storing the results of surveys, interviews, data resulting from the application of play and exercise mechanics collecting assessments, impressions, semiotic effects, etc. generated by a style element/module, as well as external DBs of portfolios, skills, reputation, affiliation, critiques, analyses, comments, etc.

For each module and element, the request analyst 202 confirms or invalidates the relative or absolute correlation between two aspects, i.e. the data to which the modules and elements refer, and the data of the set of parameters inherent to each request. The request analyst 202 does this by querying the corresponding database systems, i.e. the element and module DBS 204 and the available style producer DBS 206. Using their respective metadata, the analyst 202 chooses the modules and, indirectly, the elements for which this correlation is confirmed, and indexes them all to an analysis identifier. The analysis identifier refers to all of the data associated with the analysis performed. This trace is also recorded in the history DBS 232.

It can transmit modules to the divider 210. The latter fragments the modules and elements and sends them to the assembler 212, which merges compatible elements, coming from different modules, so as to reform new ones. Elements sharing the same style plane are compatible if they are not of the same nature and mutually respect the conditions, restrictions, etc. required by each of the elements intended to be assembled. The assembler 212 can also lighten a previously divided module.

Lightening a module means subtracting one or more elements therefrom, and reassembling the remaining elements without adding new ones. Here again, the divider 210 and the assembler 212 index a division or assembly identifier, referring to all of the data associated with their operations. This trace is also recorded in the history DBS 232.

Next, the order generator 214 reassembles the style module(s) sent by the request analyst 202. It can produce either a submission or a quotation, if a submission has already been accepted. To that end, it first queries the history DBS 232. If an accepted submission identifier is indexed to the module, it generates a quotation for the latter. Otherwise, it generates or corrects a submission.

To produce a submission, the order generator 214 queries the rights, permissions, restrictions DBS 216 to append those corresponding to the style elements making up the module thereto. It also calculates the production costs for the artwork to be produced by multiplying the number of units to be produced for each element by its cost per production unit. The same is true for the production times, which are determined by multiplying the number of units to be produced for each element by its performance time per production unit.

The order generator 214 also has access to the image DBS 224, which makes it possible to view reference graphic objects for analysis and identification purposes, for example such as comparisons or correlation searches. The order generator 214 and the image DBS 224 are also connected to the viewer 208, which displays the graphic objects, elements, or modules for consultation. Lastly, the order generator 214 generates and indexes a submission identifier, which attaches itself to a file identifier, which links all of the objects and data associated with an order. This trace is recorded in the history DBS 232.

For the generator 214 to produce the quotation, it must first have identified the submission as being accepted. This information is stored in the history DBS 232. To that end, all of the graphic objects to be produced must have been described, and compliance with all of the rights, permissions, and restrictions related to the order must be possible.

The requester 220 uses the descriptor 222 to describe each of the objects of the order. The descriptor 222 is also connected to the image DBS 224, in which it identifies reference graphic objects. It appends these graphic objects assisting with the description to the order. Next, the descriptor 222 indexes a description identifier referring to all of the data associated with its operations. This trace is also recorded in the history DBS 232.

To confirm the possibility of compliance with the rights, permissions, and restrictions, the generator 214 queries the rights, permissions, and restrictions DBS 216 in connection with two DBSs: available style element 204 and available style producer 206. In this way, it will be able to confirm or invalidate the correlation between the data to which the module-producer and element-producer pairs refer, as well as the data for all of the parameters inherent to the rights, permissions, and restrictions related to the order. This correlation must be absolute, i.e. confirmed for all of the graphic objects of the artwork.

The contrary case would explain that conditions are no longer or can no longer be respected, for example because they have expired; a validity period/expiration date may be indexed with certain objects. If necessary, the generator 214 attaches an error message to the submission and returns it to the requester 220 for revisions. If compliance with all of the rights, permissions, and restrictions related to the order is possible, the generator 214 creates a quotation, reassembles all of the related objects, including the knowledge and learning objects, and indexes each of them to a quotation identifier. In this way, any object related to all of the elements identified as being assignable to a producer 226 or to a co-producer 228 will be identified as being intended for the latter. This includes documentation, guidelines, etc.

Lastly, the generator 214 will send this group of objects, which will be called final quotation, to the sender, which will distribute them to all of the producers 226 and co-producers 228 that must be involved in the production of the artwork.

Throughout the entire process, on several occasions, the viewer 208 will make it possible to display any graphic object, element, or module for consultation purposes.

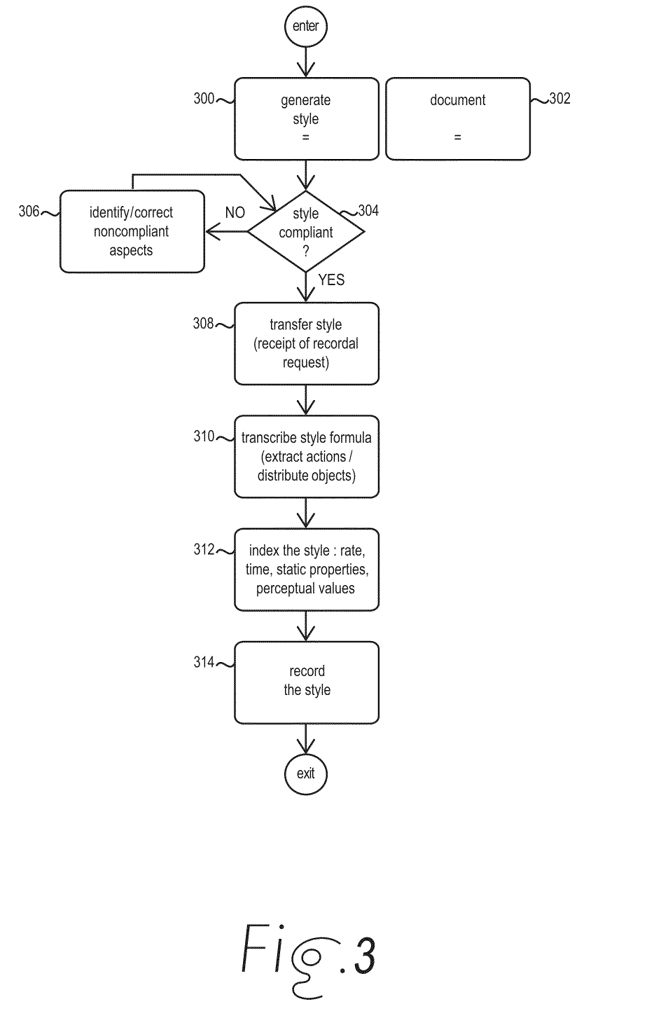

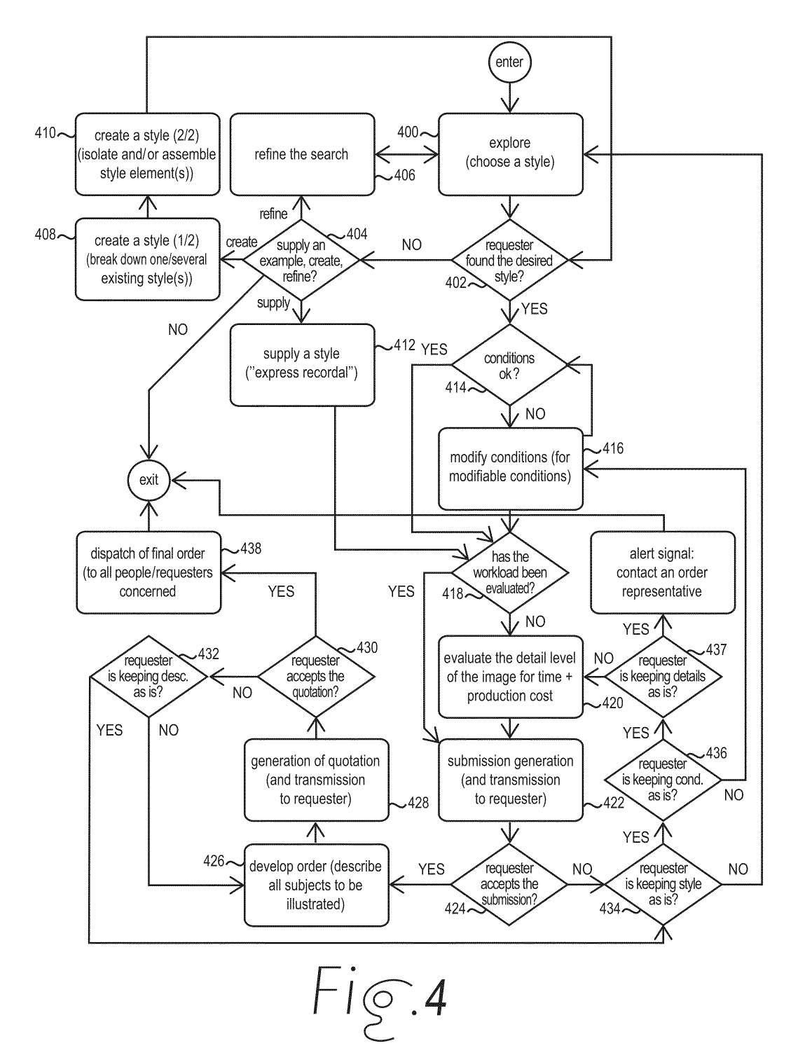

FIG. 3: Flowchart Illustrating the Recordal

The following procedures and actions have been carried out beforehand by the producer:

Before undertaking the recordal, a style 300 will have been generated and documented 302. This generation must apply to all of the graphic objects and in all of the planes presented in the generic documentary reference. Sketch, draw, surface, and color all of the graphic objects. With the style-generating software, each of the obtained elements must be placed on a separate layer, and all of the style elements making up a same graphic object must be reassembled within a same group. The projected shadows of the object, background, floor, decor, etc. will therefore represent groups belonging to different style planes.

The full save is then done. Lastly, the objects used to generate the style 300 are reassembled and attached to the save. The producer will then submit the model for transfer.

To be compliant, a model must be recorded in a file in the native format of an image-generating software application, in layers, and must be named, then identified by an existing model generation file number. The attached objects must also be named and identified using the same model generation file number as the file of the model.

If the model is deemed compliant 304, it will be transferred 308 by means of a proposal. If not, it will be redirected. It will therefore be returned to the producer through a request for identification and correction of the noncompliant aspects. The proposal will then be resubmitted to validate its compliance 304.

Once the validity of the model has been confirmed, the writer takes over to complete the recordal. Before continuing the process, a save-by-element must have been done, identified by the corresponding file number and attached to the request.

Next, the formula for the style will be transcribed 310. This step, among others, will be done with an input interface imitating the exact version of the interface of the software used to generate the model. The actions having led to the production of the model may also be identified, then recorded in real-time by a tracking system of the heatmap type. It will have deduced the functions used by identifying the placement of clicks/activated zones on the interface of the software used to generate the model. Lastly, each object will be associated with each of the actions it will make it possible to complete.

The style will also be indexed 312. In this step, the input interface will slightly change in appearance. It will display, in turn, the visual files of reproduced elements and a list of keywords and choices to be selected, corresponding to the parameter to be indexed. These parameters are identified below.

Static data attached to the object, defining, inter alio:

First, its rate, in units per production element;

Next, its nature, referring to a dimension of the artwork: shape, line, or texture;

Additionally, the style family to which it belongs;

Plus its static properties:

Its three graphic properties: realism, proportionality, and gesture;

Its chromatic property;

The two relational properties: concordance and alignment.

For any module, a cumulative value will be calculated, and a difficulty coefficient will be associated therewith.

Once all of these parameters are indexed, the recordal of the style 314 may be completed. All of the elements and other objects will be listed in the corresponding DBSs for efficient reentry.

Several parameters will later be associated with perceptual values and will modify the definition of the element or the module contextually. These are called dynamic properties. These include the emotions experienced as well as their polarity, such as positive/negative or attraction/repulsion. The ambiances given off and impressions perceived should also be noted, in addition to the degree of novelty, the popularity level, the assessment level, the commercial value, or the potential for influence with various segments.

The perceptual values can be divided into two major categories.

The tacit values, from personal interpretation, are not shared. They are felt on a personal, and therefore informal, level, and may be of various natures. For example, they may be Emotional, charged with an atmosphere they convey. They may also be related to personal culture, therefore resulting from a lifestyle or private values.

Values shared through various references are also taken into account. They are reflected and studied, and therefore more formal. They may also be of various natures. For example, they may be cultural, reflecting customs, values, and concepts shared within a same group. Still more formal, there are regional values, of a geographical, historical, or temporal nature. The concepts and values faithful to an artistic movement or the performance of a known artist are also shared, like those resulting from a professional sector, or applied art. Lastly, those related to any production technique or medium should be noted.

These properties generate dynamic data that causes them to evolve. Resulting from various events and operations, they may graft to any object, for example such as a style element/module in the case at hand.

The data set out by this collection regards the identity of the people or entities connected to the object, such as a style element/module, for example. Among that data, note should be made, inter alio, of those providing information on the operators able to reproduce the style, and those already having worked with it. This may also, however, involve indirect data, connected to each of the entities, for instance data regarding an availability calendar or available resources, such as physical equipment or software.

This may also involve data related to the culture of the people or entities connected to the style. For example, this may involve citizenship, geographical location, language(s) understood/used, general knowledge, and experience not related to the illustration.

The forces related to the trade of these entities, their personality traits, skills and experience, in years and in terms of production, are also part of the list. This also includes skills acquired, style elements/modules mastered and mastery levels, and any data related to the performance of the entity. More specifically, the entity's performance may be described by the assessment/satisfaction level concerning the productions done by the latter. Rigor, punctuality, respect for the style, graphic objects described, etc. are also considered.

The entities or categories of entities having obtained a given style element as the result of a search are associated with the concerned style. As for the search results, the same connection can be made regarding any submission, purchase or usage associated with the style.

The data related to the entity at the source of a derived request is also noted. For example, this may be the data related to its activity sector, geographical location, or role, need, goal, intention, etc. regarding the style. The information on these intentions and goals, e.g. to help consult, understand, reach, move, imagine, etc., is also taken into account.

The data related to the characteristics of the targeted recipient, such as the age, gender, socioeconomic profile, etc., is also noted. Furthermore, mention should be made of data providing information on the intention of a message using the style and intended for the recipient. For example, the invention may be to seduce, impress, recapture, require, warn, etc. Lastly, any operating history on a style and related reasons are noted.

FIG. 4: Flowchart Illustrating the Order

To place an order, the requester will first have identified the constraints determining the boundaries of the project: budget, time, requirements regarding the origin of the producer. Then, to determine the style(s) of the artwork to be ordered, he may explore 400, using various means. Each of the actions described below may be done individually, or they may be combined with one another.

One or more styles may be identified by consulting a style catalog. First, the online version of the catalog has modules that can be broken down into elements, each having an identifier related to the control interface through which it may also be entered. Connected to this identifier are the metadata defining the corresponding object, and the latter are also interconnected with one another.

Each identifier offers a link making it possible to store, combine elements and begin an order without having to enter a code. It also offers the possibility of sending the corresponding object using social media. Lastly, it contains the information regarding the time and cost per production unit, for the corresponding element or module.

The printed version can be broken down into at least two forms: a series of collectible cards and a multi-selection carrousel with toothed wheels. They offer a selection of elements or modules; each of the latter has a list of its component elements. Here again, all of the objects are associated with identifiers: an alphanumeric code and a micro 2D barcode or matrix code. The latter may be entered and interpreted using a smart device so as to store, combine elements and begin an order without needing to enter an alphanumeric code. It also offers the possibility of transmitting the corresponding object using social media. Lastly, each card displays the information relative to the time and cost per production unit, for the corresponding element or module.

A style may also first be found by an association of keywords, each of which illustrates a subjective perspective from which a request might be made: historical, geographical, cultural reference, related to a professional sector, an artistic movement, an artist, etc. It may also be found by associated perceptual value, for example, the atmospheres or emotions it should be able to evoke.

Furthermore, the requester may then refine the search 406, by assigning an objective quantity measurement, or one or more keywords corresponding to the required static properties.

A style may also be created 408-410. This may first be done by selecting one or more modules that will be broken down 408, thereby revealing each of the elements. Next, it may either be lightened or reassembled 410 with one or more elements of other modules to thereby create a new module.

Lastly, the requester may provide a style 412, i.e. transmit a custom drawing or an example located and submitted as a reference. Thus, for each recognized element, characteristics would be identified and associated with the style elements from the catalogue or another object coming from a library. The style could then be found 402 without exploration 400.

Once the style(s) to be associated with the order have been identified 402, the concordance of the conditions 414 with those required by the project must be verified. These conditions may relate to: production time, partial or final delivery date, anticipated budget, detail level, type of plane (foreground, background), experience of the producer, skill of the producer, co-producer or production team, performance of the producer, co-producer or production team, level of knowledge, by subject, of the producer, co-producer or production team, punctuality of the producer, co-producer or production team, history of the producer, co-producer or production team, origin of the producer, co-producer or production team, language spoken by the producer, co-producer or production team, region of residence of the producer, co-producer or production team, as well as the rate level and time zone associated with that region, value of the contribution by the producer, co-producer or production team, responsibility level and status of the producer, co-producer or production team, copyright management type related to the producer, co-producer or production team, level of exclusivity required for the image that will be produced, etc.

In the event of discordance, the rights and permissions related to each object to be aligned will determine whether the conditions to be modified may in fact be modified. If they can, the modification 416 will be done. If not, one or more other styles will have to be chosen 400-412. In the event of concordance 414, the completion of the assessment of the workload will be invalidated or confirmed 418.

The assessment of the workload 420 consists, inter alio, of defining the components in the boundaries of the image. It must be completed before the submission is generated 422 and transmitted to the requester.

The workload associated with an order is first assessed 420 using a list. This involves counting the graphic objects to be illustrated, in terms of production units, but without describing said graphic objects. The nature of the subjects, each associated with an approximate number of production units, may have been determined beforehand. It will, however, also be possible to specify the level of detail of the graphic objects: to calculate, as accurately as possible, the value in terms of production units, by comparing the density with different versions of a model image, each having a given detail level. The model images would have image versions going from very refined to very heavy. The production costs and times related to each style are multiplied by the number of units to be produced for each one. The total production costs and times related to the order are thus obtained.

The requester must accept or obtain acceptance from the recipient of the submission generated 422, by verifying the concordance thereof with the project. It is then possible to determine whether it will be suitable for the target audience. In the event of discordance, i.e. if the submission is not accepted, the requester must determine whether the style(s) will remain as is 434.

If not, one or more other styles will have to be chosen 400-412. In the affirmative, it will next be necessary to determine whether the conditions will be kept as is 436.

If not, it will modify the conditions for which the rights and permissions, related to each object to be aligned, allow it. In the affirmative, the modification 416 will be done. Otherwise, one or more other styles will have to be identified 400-412. Lastly, if the generated submission 422 passes the acceptance step 424, the order may be developed 426.

The development ends with the generation of a quotation 428, but first starts with the description, which includes two steps, i.e. detailing and connecting.

Detailing consists of describing each graphic object to be illustrated in a natural language relative to its nature and appearance. For a person, the detail will include the figure's apparent age, its measurements or the equivalent thereof, its clothing, posture, attitude, and actions, as well as the emotions and atmospheres evoked by the latter.

Connecting first consists of establishing relationships between the characters and, potentially, interacting graphic objects. These relationships are then enriched, through actions and attributes, which may be behavioral, emotional, circumstantial, etc.

The step for confirming the quotation 430 will be passed if the requester accepts or obtains acceptance of the generated quotation 428, by the recipient, by verifying its concordance with the project. It is then possible to determine whether it will be suitable for the target audience. In the event of discordance, the requester will have to determine whether it will keep the descriptions as is.

If not, it will resume development of the order 426. In the affirmative, the requester will have to determine whether it will keep the style(s) as is 434.

If not, one or more styles will have to be chosen 400-412. In the affirmative, it will next be necessary to determine whether the conditions will be kept as is 436.

If not, it will modify 416 the conditions for which the rights and permissions, related to each object to be aligned, allow it. In the affirmative, the modification 416 will be done. Otherwise, one or more other styles will have to be identified 400-412.

The sending step 438 may be undertaken as a confirmation of the quotation 430. It consists, inter alia, of sending the order to all of the producers required for its completion. Each of the producers will receive a copy of the complete order, with emphasis on the tasks specifically assigned to him. In this step, a project code will have been associated with the order. It will contain all of the information necessary to collect the resources and objects in time that are required to complete the specifically assigned tasks.

This inventory will be presented in the form of a short video including one or more capsules. It will be produced by automated collection, and oriented by the metadata associated with the objects.

A capsule may contain all types of objects, including learning objects to reproduce style elements, or reference resources and tools, such as schedules, order summaries, points, checklists, as well as visual reference documentation, such as color palettes to be used, graphic styles, outlines, textures, patterns, or other resources that may be integrated into the artwork. Dynamic links with external sources and DBs able to provide these references may be established (not shown).

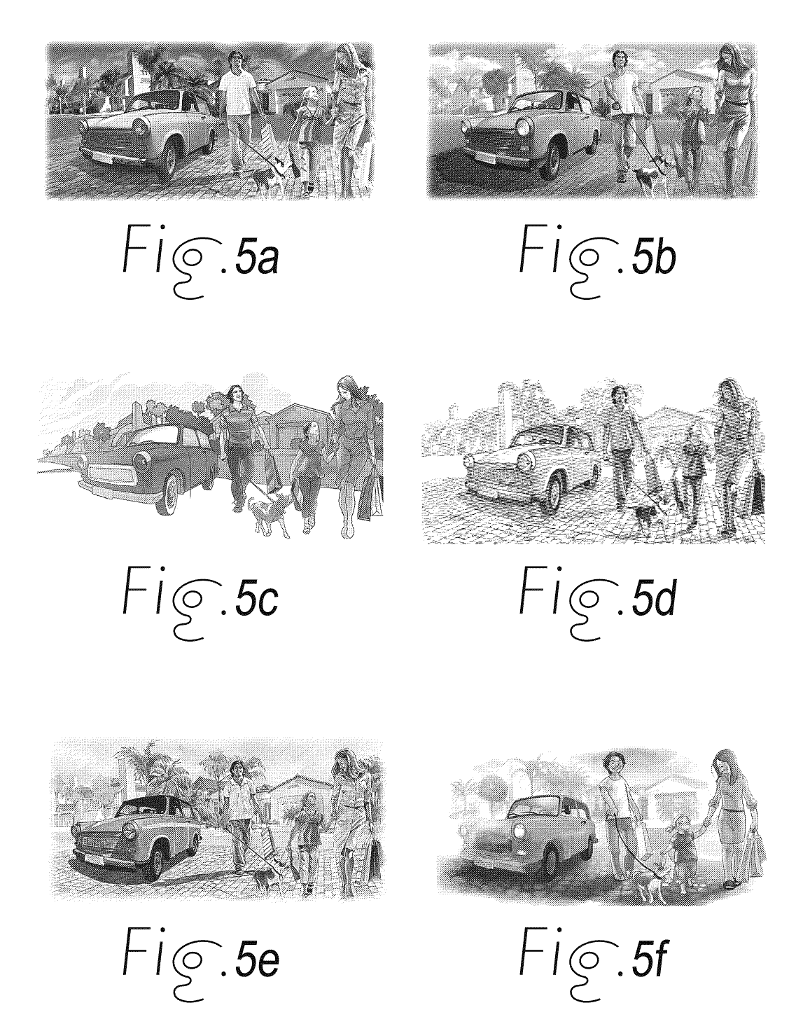

Description of FIG. 5a: generic documentary reference

Photo montage used as reference to produce the models shown in FIGS. 5b, 5c, 5d, 5e and 5f.

Description of FIG. 5b: model showing a realistic style

Illustrates a graphic depiction relatively faithful to reality.

Description of FIG. 5c: model showing a fantastical style

Illustrates a personal, artistic interpretation from new media.

Description of FIG. 5d: model showing an etched style

Illustrates an interpretation of a traditional artisanal technique.

Description of FIG. 5e: model showing a watercolor style

Illustrates a graphic depiction done using a traditional medium.

Description of FIG. 5f: model showing a comic strip style

Illustrates an interpretation of a cultural reference also related to an applied art sector.

Description of FIG. 6: graphic objects to produce a model

FIG. 6 illustrates examples of graphic elements, including the two main elements required to produce a model example 604: a reference image example 600, as well as a generic documentary reference example 602.

The style, which makes it possible to depict the subjects of the reference image 600, i.e. the giraffe, the child, and the landscape, will be formalized for analysis purposes. In order to achieve the right perspective and to be able to compare it to the others, any style to be recorded is reproduced to depict a standardized group of subjects, i.e. the same generic documentary reference 602. This results in the model 604.

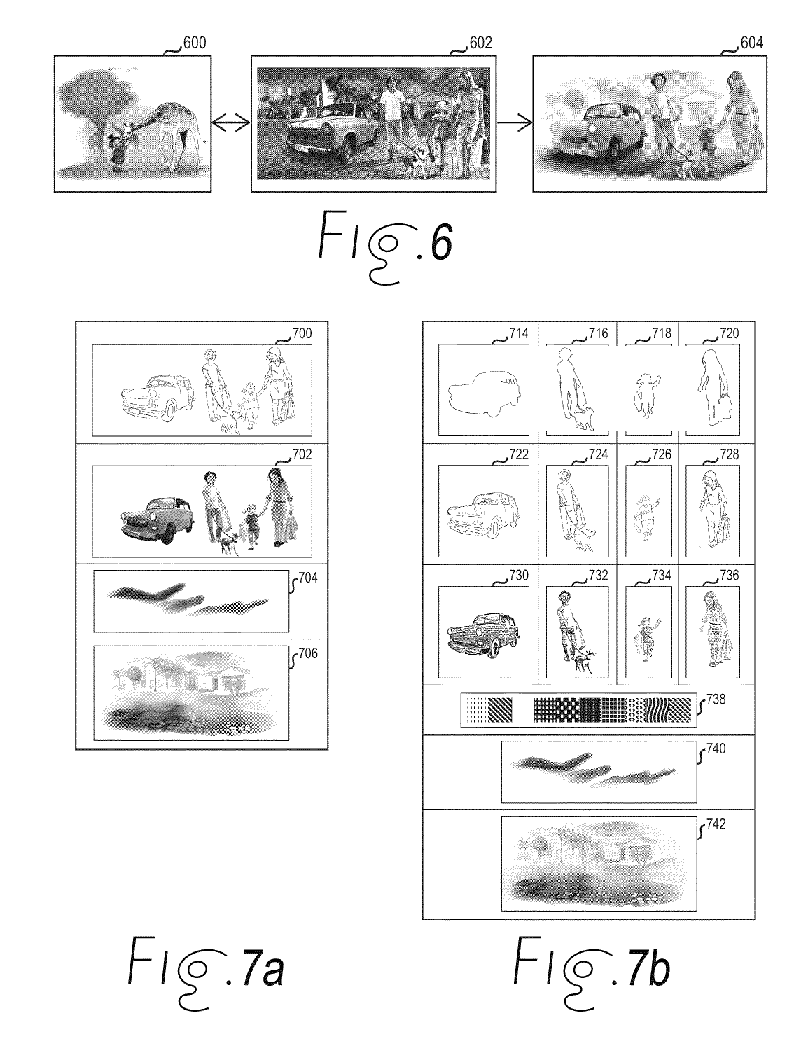

Description of FIG. 7a: example of a full save

FIG. 7a illustrates an example of a full save, showing the objects that may be found therein. First, the image contained in a file for which a full save has been done is not flattened. This means that any graphic objects making up the depiction of all of the subjects, by means of an element or an inseparable group of elements, must be able to be manipulated alone. To that end, these graphic objects must be positioned on independent layers.

In the present example, the depiction of the four elements in the foreground is illustrated by two groups of elements. In the first 700, the shape is implicitly shown and easily separable from the line, which is well-defined. In the second 702, the shape is also implicitly shown separately from the texture and the color, the latter nevertheless being merged. For the background, there is a group of three merged elements: shape, color and texture.

For a full save of this image, the subjects will therefore be unseparated, but the depictions of the style elements making them up will be distributed on three layers. The save will be done in the native format, in high resolution, named as being full and identified by its corresponding file number. This file also contains all of the objects used to generate the model: those making it possible to produce effects, such as, for example, a brush applying a watercolor paint (not shown), to reproduce textures, such as, for example, those of images having the appearance of various types of canvas (not shown), and to harmonize the colors, for example, with palettes (not shown).

Description of FIG. 7b: example of a save-by-element

FIG. 7b illustrates an example of a save-by-element, showing the objects that should normally be found therein. First, the image used to generate the saves of individual elements, contained in a file for which a save-by-element has been done, is not flattened. This means that any graphic object making up the depiction of each subject, through an element or a group of inseparable elements, must be able to be manipulated alone. To that end, these graphic objects must be arranged in separate layers, also grouping them together by subject depicted. Furthermore, a depiction of each element forming each object must be able to be associated with a style plane specific to it (not shown).

In the present example, the shape-element 714-720, the texture-element 730-736, and the color-element 738 have been formalized from the full save file shown in FIG. 7a. The shape-element 714-720 has been isolated from the texture-element 730-736. Also, if the new element is proposed in the background image, it must also be isolated. This is the case in the present example, where the texture-element 740-742 has been formalized by subtracting the color-element 728, which had already been formalized.

For a save-by-element, the recordal will first be done in the native format, in high resolution, named as containing the elements and identified by its corresponding file number. However, as mentioned, the depiction of each style element, for each subject, will have to be isolated. A second recordal step will be done, for each graphic object corresponding to an element of a subject of the model, in an inherited format, in high resolution, then a third, and in low resolution.

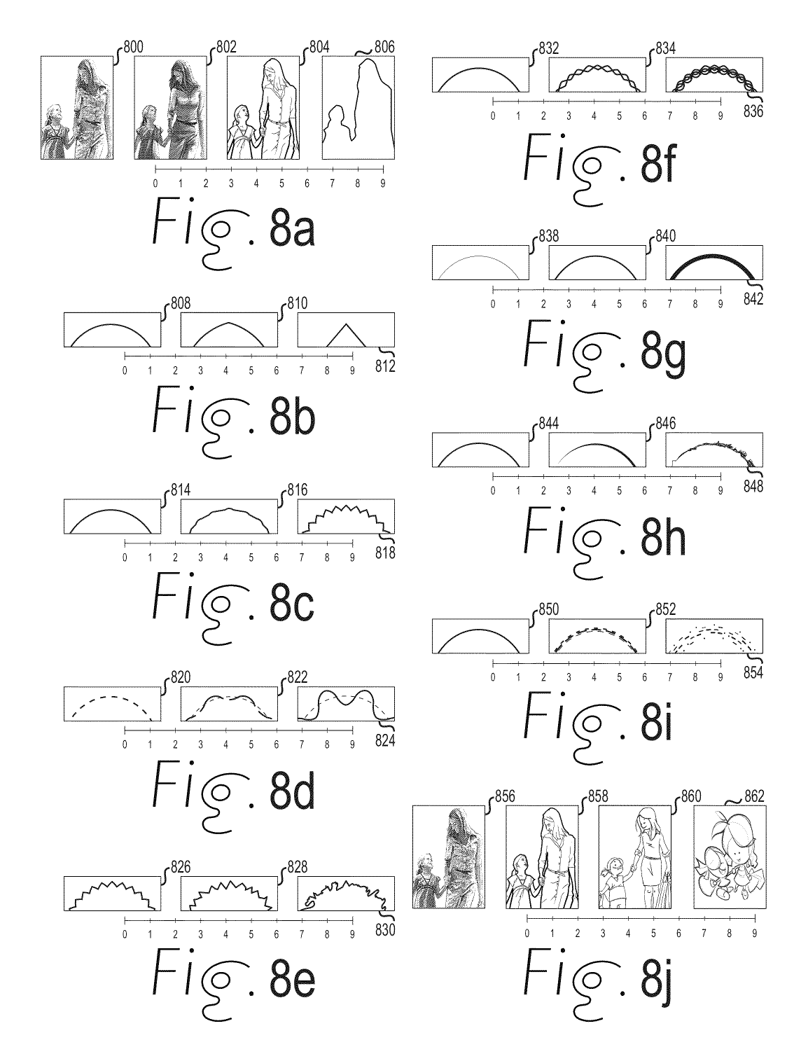

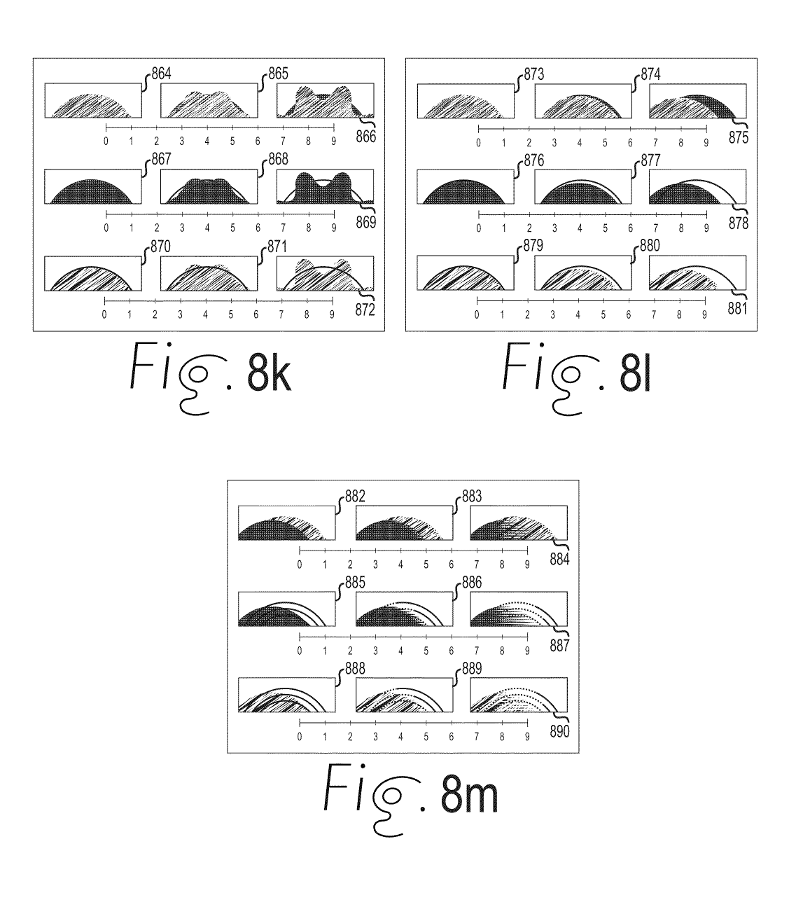

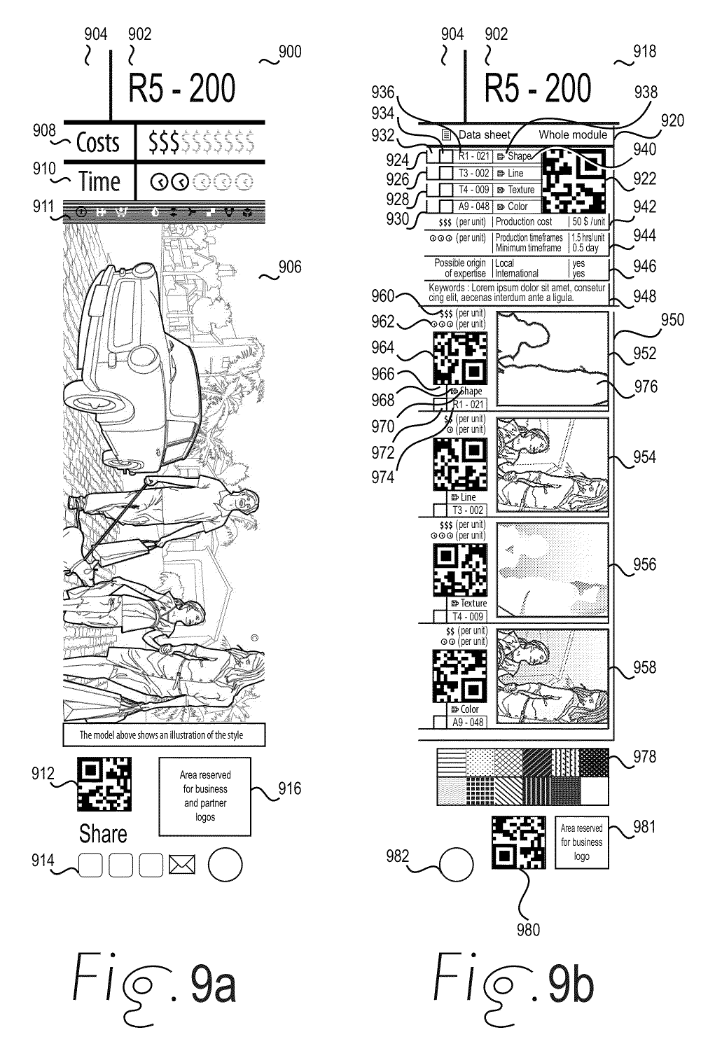

Description of FIG. 8a: level of respect for reality; realism

FIG. 8a shows different levels of respect for reality. A generic documentary reference 800 is shown as well as three examples illustrating three levels of realism with which a graphic object may be marked. In this example, they are rated on a scale of zero to nine. The first 802, located close to zero, is close to the analogical level; the second 804, located close to five, proposes an average level of realism; and the third 806, located close to nine, shows a more arbitrary depiction.

Description of FIG. 8b: parameters defining the gesture; orientation.

FIG. 8b illustrates three insistence levels, using three examples, to define the gesture property consisting of the orientation. They are rated on a scale of zero to nine. The first 808, located close to zero, is the most rounded. The second 810 suggests a gesture that is equally rounded and angular. The proposal of the third 812 is more angular.

Description of FIG. 8c: parameters defining the gesture; fluidity.

FIG. 8c illustrates three insistence levels, using three examples, to define the gesture property consisting of the fluidity. They are rated on a scale of zero to nine. The first 814, located close to zero, is the most fluid. The second 816 suggests an average fluidity. The proposal of the third 818 is more rough.

Description of FIG. 8d: parameters defining the gesture; amplitude.

FIG. 8d illustrates three insistence levels, using three examples, to define the gesture property consisting of the amplitude. They are rated on a scale of zero to nine. The first 820, located close to zero, suggests a shorter gesture, with a lower amplitude. The second 822 suggests an average amplitude. The proposal of the third 824 has a longer amplitude, illustrating a more ample gesture.

Description of FIG. 8e: parameters defining the gesture; direction.

FIG. 8e illustrates three insistence levels, using three examples, to define the gesture property consisting of the amplitude. They are rated on a scale of zero to nine. The first 826, located close to zero, is the most controlled. The second 828 suggests a more or less controlled gesture. The proposal of the third 830 is freer.

Description of FIG. 8f: parameters defining the gesture; density.

FIG. 8f illustrates three insistence levels, using three examples, to define the gesture property consisting of the density. They are rated on a scale of zero to nine. The first 832, located close to zero, is the most refined. The second 834 suggests an average density. The proposal of the third 836 is denser.

Description of FIG. 8g: parameters defining the gesture; intensity.

FIG. 8g illustrates three insistence levels, using three examples, to define the gesture property consisting of the intensity. They are rated on a scale of zero to nine. The first 838, located close to zero, suggests a weaker, more restrained gesture. The second 840 suggests an average intensity. The proposal of the third 842 is more energetic, with a higher intensity.

Description of FIG. 8h: parameters defining the gesture; constancy.

FIG. 8h illustrates three insistence levels, using three examples, to define the gesture property consisting of the constancy. They are rated on a scale of zero to nine. The first 844, located close to zero, suggests a more regular gesture. The second 846 suggests an average constancy. The proposal of the third 848 is more irregular.

Description of FIG. 8i: parameters defining the gesture; demarcation.

FIG. 8i illustrates three insistence levels, using three examples, to define the gesture property consisting of the demarcation. They are rated on a scale of zero to nine. The first 850, located close to zero, shows a gesture with sharper, cleaner boundaries. The second 852 suggests boundaries of average sharpness. The proposal of the third 854 illustrates more vague boundaries.

Description of FIG. 8j: level of respect for proportions; proportionality

FIG. 8j shows a generic documentary reference 856, and three examples illustrating the same number of levels of respect for the proportions with which a graphic object may be marked. In this example, they are rated on a scale of zero to nine. The first 858, located close to zero, proposes a more proportional depiction; the second 860, located close to five, proposes an average level of respect; and the third 862, located close to nine, shows a more disproportionate depiction.

Description of FIG. 8k: relational properties between elements: concordance

FIG. 8k illustrates three insistence levels, using the same number of examples, to define the concordance level that may exist, per dyad, between the elements making up the three possible pairs. They are rated on a scale of zero to nine.

For the shape-texture concordance level, the first 864, located close to zero, proposes a concordant relationship. The second 865 suggests a relationship of average concordance. The proposal of the third 866 is more discordant.

For the shape-line concordance level, the first 867, located close to zero, proposes a concordant relationship. The second 868 suggests an average concordance. The proposal of the third 869 is more discordant.

For the line-texture concordance level, the first 870, located close to zero, proposes a concordant relationship. The second 871 suggests an average concordance. The proposal of the third 872 is more discordant.

Description of FIG. 8l: relational properties between elements: alignment

FIG. 8l illustrates three insistence levels, using three examples, to define the level of alignment that may exist—per dyad—between the elements making up the three possible pairs. They are rated on a scale of zero to nine.

For the shape-texture alignment level, the first 873, located close to zero, proposes an adjusted one. The second 874 suggests an average level. The third 875 is more offset.

For the shape-line alignment level, the first 876, located close to zero, proposes an adjusted one. The second 877 suggests an average level. The third 878 is more offset.

For the line-texture alignment level, the first 879, located close to zero, proposes an adjusted one. The second 880 suggests an average level. The third 881 is more offset.

Description of FIG. 8m: relational properties between elements: integration.

FIG. 8m illustrates three insistence levels, using three examples, to define the integration level that may exist—per dyad—between the elements making up the three possible pairs. They are rated on a scale of zero to nine.

For the shape-texture integration level, the first 882, located close to zero, proposes a separated one. The second 883 suggests an average level. The third 884 is more integrated.

For the shape-line integration level, the first 885, located close to zero, proposes a separated level. The second 886 suggests an average level. The third 887 is more integrated.

For the line-texture integration level, the first 888, located close to zero, proposes a separated level. The second 889 suggests an average level. The third 890 is more integrated.

Description of FIG. 9: structure of a style card

A style card is printed front and back and displays information on both of the surfaces relative to a style module usually made up of 4 elements. On the front 900, there is first the identifier, the style code 902 associated with the module shown. In the upper left corner, a color code 904 indicates the style family to which the module is most closely related overall.

This surface is largely illustrated by the model 906, which is a depiction of the overall appearance obtained by the mixture of the elements making it up.

Just below the style code 902 is the overall cost marker 908 and the overall time marker 910. The overall cost marker 908, which contains between one and ten dollar signs, indicates the cost scale, per production unit, associated with the module. For example, three dollar signs indicate a relatively low production cost, five dollar signs correspond to an average production cost, and seven dollar signs indicate a relatively high production cost. Following the same logic, the overall time marker 910, which consists of between one and five clock symbols, indicates the time scale, per production unit, associated with the module. For example, one clock symbol indicates a short production time, three symbols correspond to an average production time, and five symbols indicate a long production time.

Below this, a strip 911 shows nine icons for nine parameters: white, if applicable to the concerned module, and the others show just beneath the surface. The first three icons from the left provide information on the relational and transactional aspect of the module. The circled number 1 indicates that the module cannot be broken down, whereas the puzzle piece indicates that it can The basket with the arrow indicates the possibility of placing an order without an intermediary. Just to the right of the basket with the arrow, the other six icons each illustrate a depiction mode that can be used to produce an illustration in the concerned style. The mode choices are: traditional, collage, multimedia, matrix, vector, or 3D.

In the bottom left corner is the sharing code 912, i.e. a QR or matrix code that makes it possible to share an electronic version of this card through various social networks 914 and by e-mail.

The lower right corner is reserved for the logos 916 of the business and any partners.

On the back 918 of the card, under the style code 902 and the color code 904, is the data sheet for the module 920. This sheet first contains the module-order code 922. This is a QR or matrix code making it possible to open a file directly, on a web interface used to explore, create, and place orders and other requests with the corresponding module as the starting point.

To its left are the basic shape 924, line 926, texture 928, and color 930 data. Each of these data groups has, from left to right: an indicator area 932 reserved for icons related to any restrictions, a color code 934 indicating the style family to which the element is most closely related, its element code 936, as well as a puzzle piece icon 938 whereof the color indicates whether it may be reproduced alone or if it must be reproduced with another. Lastly, the element is identified by nature 940.

Below this are the details of the production costs per module-unit 942, production times per module-unit and minimum time 944, and the possible origin of the producers 946. There is also a short list of keywords 948 for the main concepts defining the module, from controlled and consensual vocabulary.

The central portion of the back 918 is reserved for the element data sheets: shape 952, line 954, texture 956, and color 958. Each of these sheets has, from left to right: a production cost marker per element-unit 960 and a production time marker per element-unit 962. The production cost marker per element-unit 960, which contains between one and five dollar signs, indicates the cost scale, per production unit, associated with the element. For example, one dollar sign indicates a low production cost, three dollar signs correspond to an average production cost, and five dollar signs indicate a high production cost. Following the same logic, the production time marker per element-unit 962, which contains between one and three clock symbols, indicates the time scale, per production unit, associated with the element. One clock symbol indicates a short production time, two clock symbols correspond to an average production time, and three clock symbols refer to a long production time.

Below this is an element-order code 964. This is a QR or matrix code making it possible to open a file directly, on a web interface used to explore, create, and place orders and other requests with the corresponding element as the starting point. Under this code is an indicator area 966, a color code 972, and an element code 974, as well as a puzzle piece icon 968 and the identification of the nature 970 of the element. This is a reminder of the corresponding indicator area 932, color code 934, and element code 936, as well as the puzzle piece icon 938 and the identification of the nature 940 of the element. Lastly, to the right of this information, a partial and isolated depiction 976 of the element is provided.

At the bottom of the back side 918, a formalized version of the color palette 978 is broken down. A QR or matrix code, situated just below it, makes it possible to access the electronic version of this palette as well as its source. This is the pallet code 980. Lastly, at the very bottom of the card, there is an area 981 reserved for the company's logo, as well as a perforation: it is located on the left side of the back 918 and on the right side of the front 900.

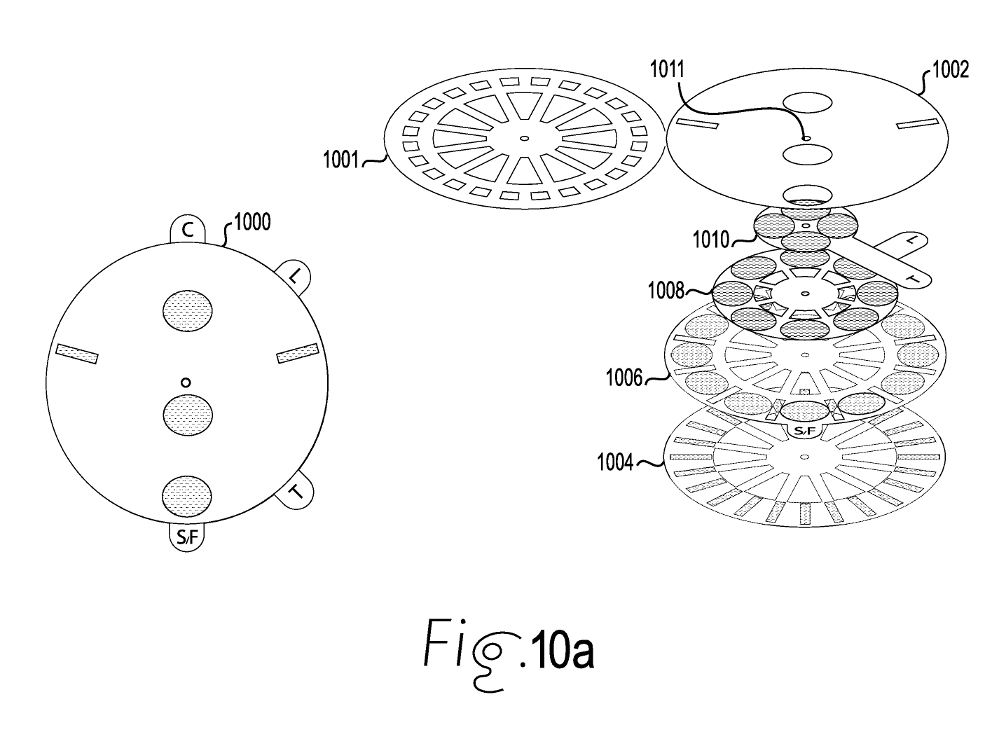

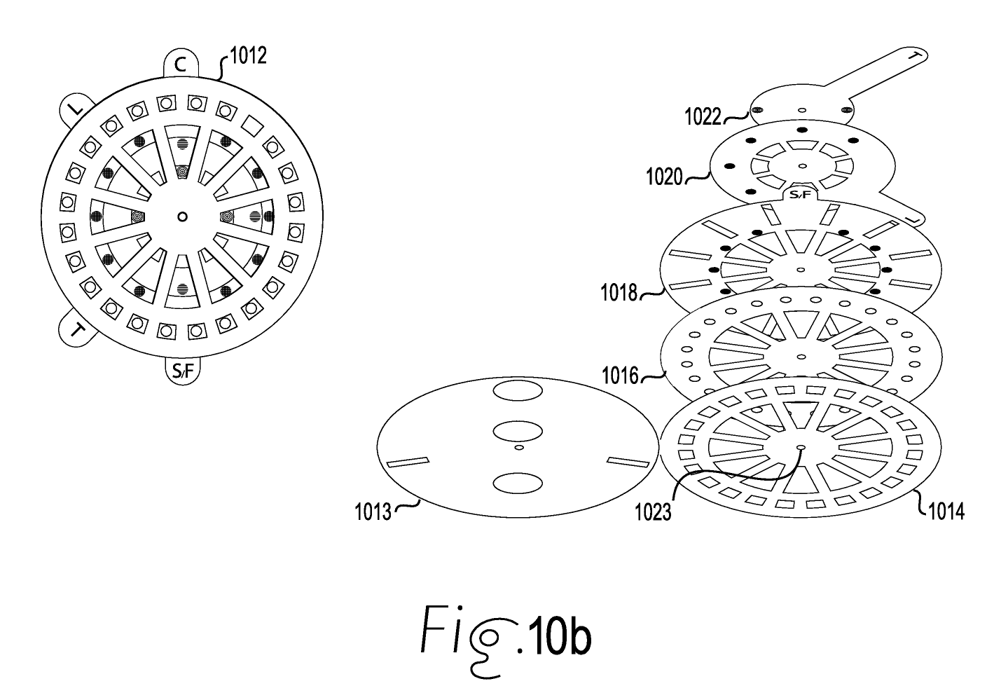

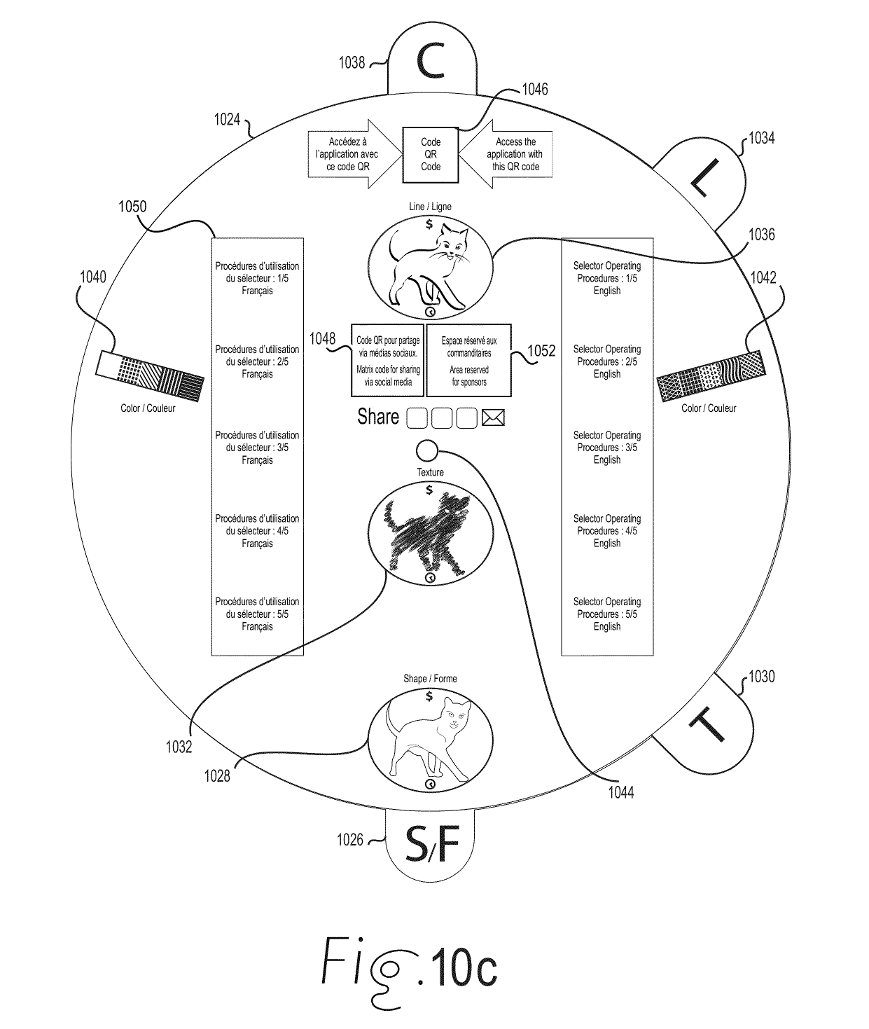

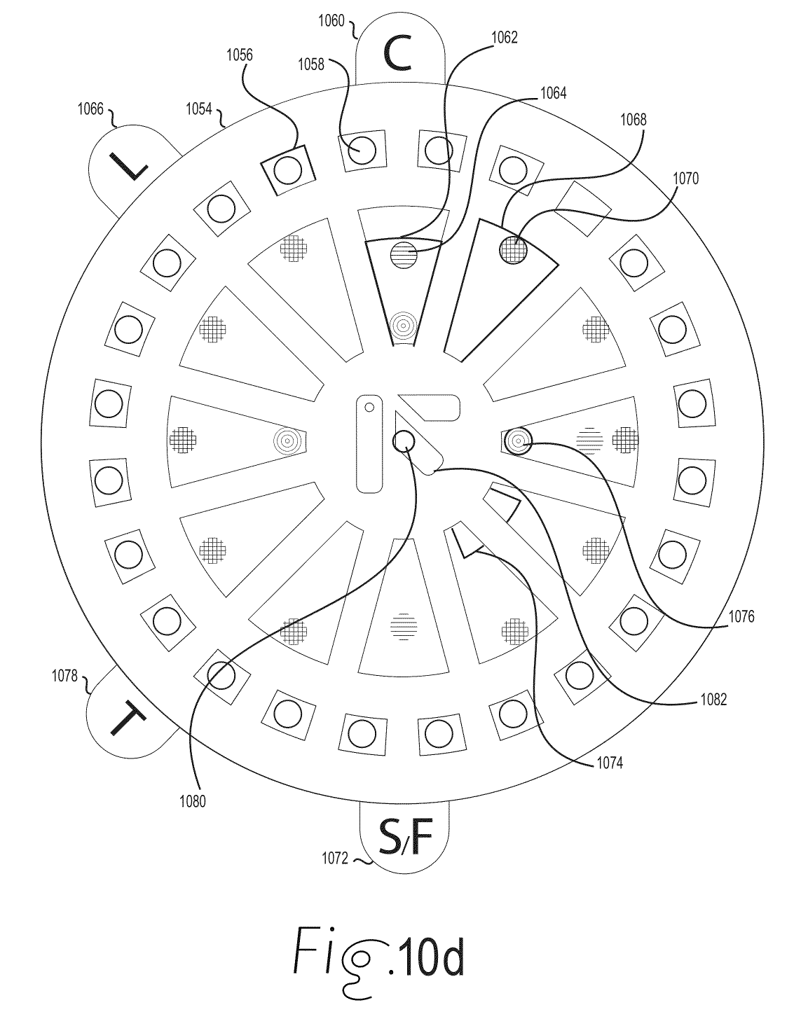

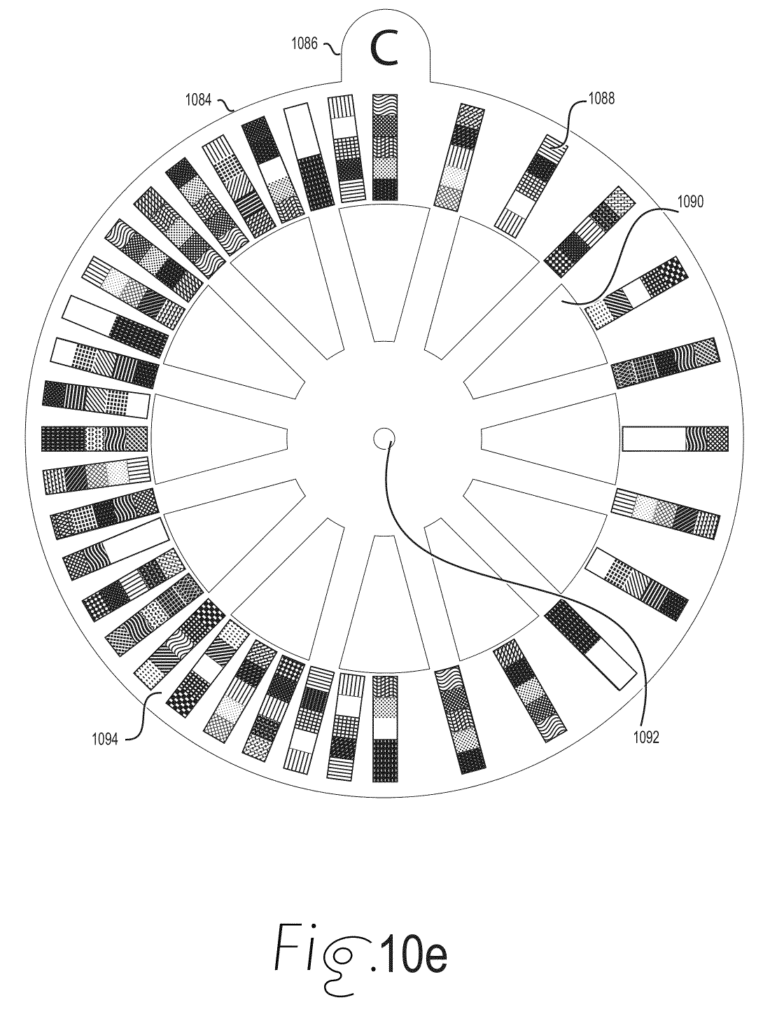

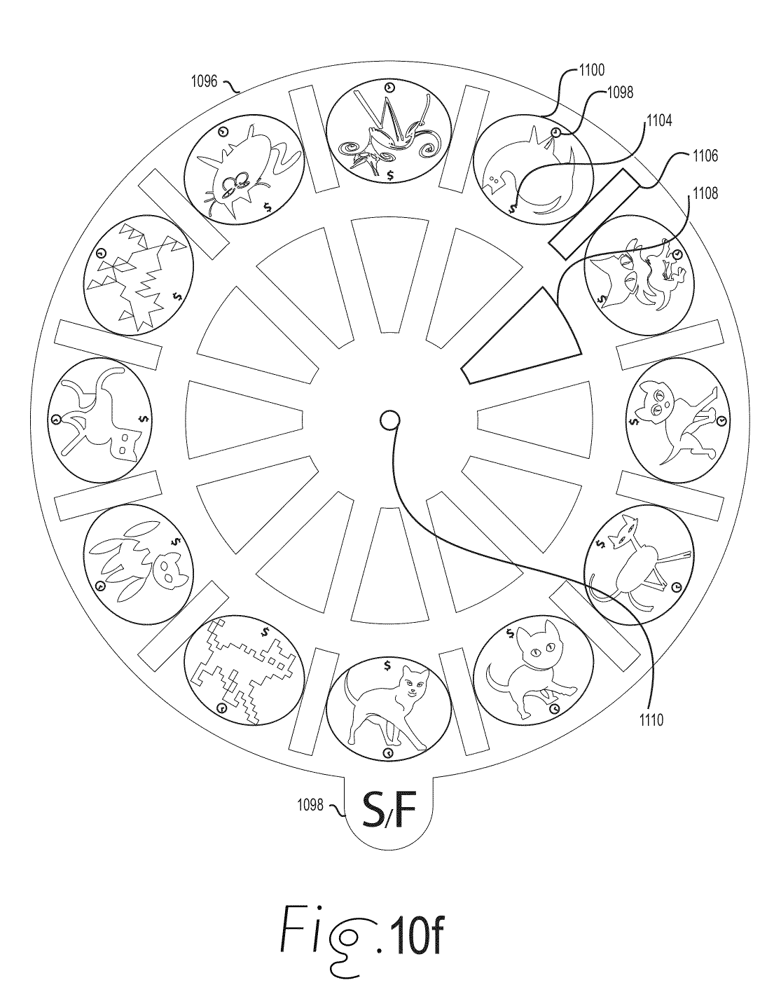

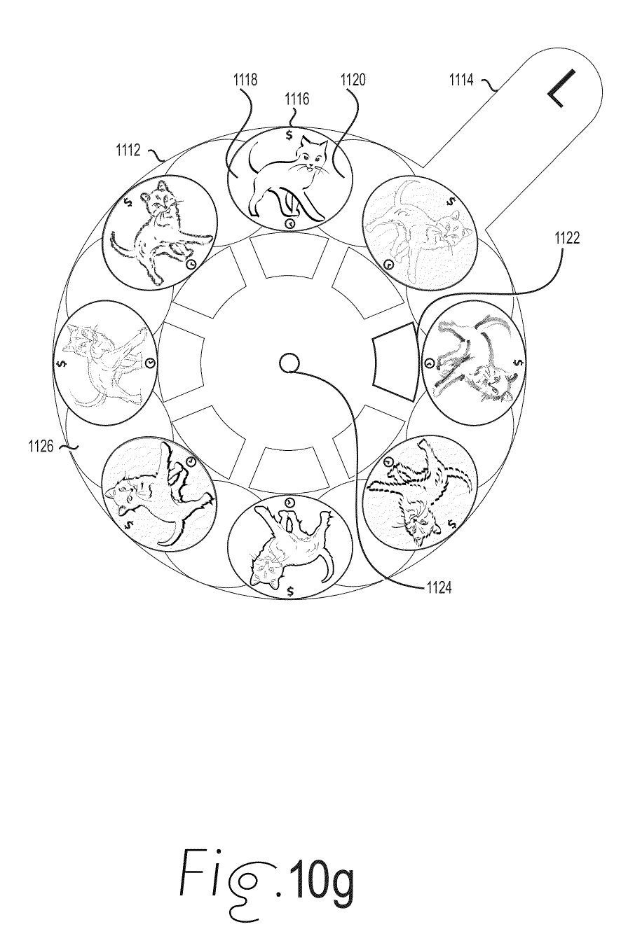

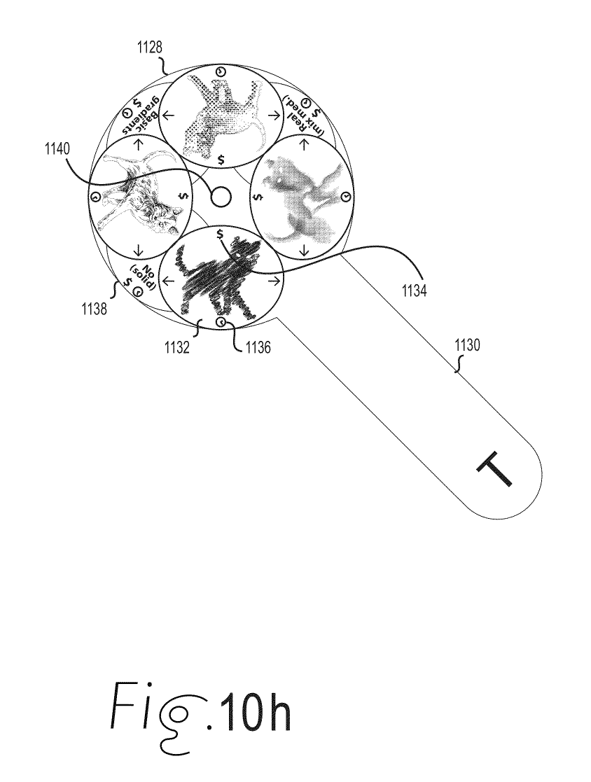

Description of FIG. 10a: structure of a multi-selection carousel; front

The front view 1000 of a multi-selection carousel shows us the buyer's perspective; it is made up of five interdependent pieces forming six disks attached at the center 1011 thereof. Four of those disks, the dials 1004, 1006, 1008 and 1010, each display information regarding the style elements of a same nature, on the front: color, shape, line, or texture, respectively. The fifth piece is made up of the disks 1001 and 1002 that are folded on one another, to gather the four dials, thereby serving as a jacket.

Description of FIG. 10b: structure of a multi-selection carousel; back

The back view 1012 of a multi-selection carousel shows us that it is made up of five interdependent pieces forming six disks attached at the center 1023 thereof. Four of these, the dials 1016, 1018, 1020 and 1022, each display a series of code points on their backs, the color of which depends on the nature of the elements for which they bear the information. They thereby form a border ring. The fifth piece is made up of the disks 1013 and 1014, folded on one other, to gather the four dials, thereby serving as a jacket.

Description of FIG. 10c: detailed front view of the multi-selection carousel

As for the dials, the centers of the front 1024 and back 1072 of the jacket bear holes and are passed through by an axis of rotation 1044. The front 1024 is perforated in five other locations, forming the same number of windows each showing the model of a selected element. Thus, the handle 1038 turns the color dial 1004, which shows one of its models with its time/cost icons, through the windows 1040 and 1042. The handle 1026 turns the shape dial 1006, which shows one of its models with its time/cost icons, through the window 1028. The handle 1034 turns the line dial 1008, which shows one of its models with its time/cost icons, through the window 1036. The handle 1030 turns the texture dial 1010, which reveals one of its categories of models with its time/cost icons, through the window 1032.

Description of FIG. 10d: detailed back view of the multi-selection carousel

This set of rotations and combinations of styles, the overviews of which are shown by the windows 1028, 1032, 1036, 1040 and 1042 of the front 1024, corresponds, on the back 1054 of the jacket, to a unique arrangement of code points situated on the back of the four dials 1016, 1018, 1020, 1022. This small disk, formed from a central circle, a ring 1013, and all of these code points, constitutes a circular module identifier, or a digitizable matrix code such as a QR code. A space 1082, in the central circle, bears the business's logo. The colored ring 1013 shows white dots 1058 through its apertures 1056.

By digitizing the circular module identifier with a mobile digital apparatus, one accesses a style card including its detailed technical sheet and the depiction of the overall appearance of the style module obtained by mixing the joined elements, thereby participating in its composition. Other assembly proposals also accompany this depiction, for a refined, in-depth search.

The application making it possible to digitize the circular module identifier is accessible by digitizing the QR or matrix code 1046, situated on the back 1054. The illustrated usage procedures 1050 appear on the same surface, in French and English.

The sharing code 1048, either a QR or matrix code, appears at the center and makes it possible to share the usage of that tool through different social networks and by email.

The space to its right is reserved for the logos 1052 of any partners.

Description of FIG. 10e: detailed front view of the color dial

The color dial 1084 can be rotated around its pivot point 1092 using its handle 1086. Different color palettes 1088 are printed on its front. It is perforated in several locations to form windows 1090 on its front/1068 on its back, which show the code points situated on the back of other dials. Intermediate positions 1094 for example request the absence of color, or a simple/complex treatment of the colors in the illustration. The code points 1058 of this dial appear on the back.

Description of FIG. 10f: detailed front view of the shape dial

The shape dial 1096 can be rotated around its pivot point 1110, using its handle 1098. Images and information regarding several shape elements, or different shape models 1100, are printed on its front, each connected to a time icon 1102 and a cost icon 1104, the color of which respects a code referring to the quantity, time and budget necessary to carry out a production unit, broken down into the corresponding style. This shape dial 1096 is perforated in several locations to form windows 1106 showing palettes 1090 of the color dial. Windows 1108 on its front and 1062 on its back show the code points located on the back of other dials. The code points 1070 of this dial appear on its back 1070.

Description of FIG. 10g: detailed front view of the line dial

The line dial 1112 can be rotated around its pivot point 1124 using its handle 1114. Images and information regarding various line elements, or different line models 1116, are printed on its front, each connected to a time icon 1120 and a cost icon 1118, the color of which respects a code referring to the quantity, time and budget necessary to carry out a production unit, broken down into the corresponding style. This shape dial 1112 is perforated in several locations to form windows 1122 on its front and 1074 on its back, showing the code points located on the back of other dials. Intermediate positions 1126 for example request the absence of a line, or a simple/complex treatment of the lines in the illustration. The code points 1064 of this dial appear on the back thereof.

Description of FIG. 10h: detailed front view of the texture dial

The texture dial 1128 can be rotated around its pivot point 1140 using its handle 1130. Images and information regarding various texture elements, or different texture family models 1132, are printed on its front, each connected to a time icon 1136 and a cost icon 1134, the color of which respects a code referring to the quantity, time and budget necessary to carry out a production unit, broken down into the corresponding style. Intermediate positions 1138 for example request the absence of texture, or a simple/complex treatment of the textures in the illustration. The code points 1076 of this dial appear on the back thereof.

This multi-selection carousel can also be shown virtually.

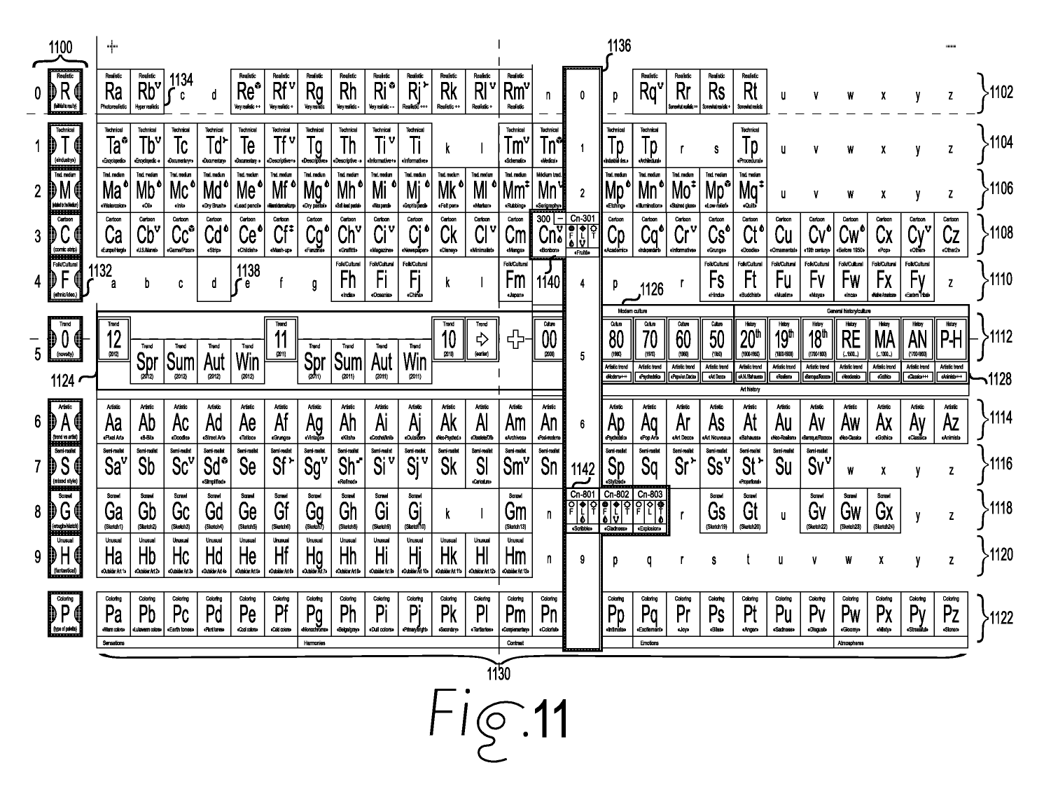

Description of FIG. 11: structure of the periodic table of style elements

The periodic table of the style elements shows a systematic classification of the elements that can be used within the system studied in this document. Thus, it highlights their properties, makes it possible to locate them, isolate them, and quickly and easily compare them. It allows an overview of the richest style families 1100 and makes it possible to target, according to the properties they must have, the types of elements that can balance and/or complete the collection. These available places 1138 are recognized by the empty space they leave.

The table is made up of ten rows 1102 to 1122. Each shows a style family 1100 and its respective elements. The latter are distributed over a grid whereof each space is identified by a letter of the alphabet 1130, following the same logic, with two exceptions.

The first exception concerns row 1112, which brings together elements of all natures not exclusively for their plastic properties, but according to two logics. First, on the left, the first half of this row 1124 ranks the elements according to the mode phenomenon they create, have created, or call to mind. This phenomenon refers to their strong cultural impact and their novelty. They are arranged from the most recent, on the left, to the oldest, on the right. Further to the right, the second half brings together the cult styles. First, as part of modern culture, are those having a strong cultural impact over the last few decades. The styles that follow result from major artistic movements and dominant trends of the main historical periods 1128.

The second exception relates to row 1122, which brings together only the color elements, displaying the palette genres, by theme evoked. These themes are sensations, harmonies, contrasts, emotions, and atmospheres. Sub-genres are related to these, for example dull, hazy, stressful, psychedelic, evoking various atmospheres. The color palettes could also be ranked by type of use, such as colorist, intimate or luminist, for example.

It should be noted that with the exception of row 1122, each of the rows such as 1100 is associated with a number. Thus, the top row 1102 is associated with 0, and the bottom 1122 is associated with 9.

The upper rows 1102, 1104 located close to 0 bring together styles reflecting a more conventional approach to the illustration, more widely shared. The elements of the first rows from the top demonstrate a practically null interpretation of reality, then adopt a formal approach, following technical conventions and standards 1106, 1008. The following rows have styles that pertain to shared locations or general, geographical, ethnic/folkloric culture, etc. 1110 or from an elementary perspective on the history 1128.

The lower rows 1114, 1116 approaching 9 bring together styles reflecting an increasingly personal approach to the illustration. They involve a freer interpretation of reality, a more intimate vision. These rows first show elements reflecting more general trends and phenomena 1126, then resulting from sub-cultures, shared by increasingly limited population groups 1124. Lastly, the last rows 1118, 1120 show the most fantastical and unusual styles. Thus:

Row 0 groups together the so-called Realistic styles: very faithful to reality,

Row 1 groups together the so-called Technical styles: resulting from a trade/sector,

Row 2 groups together the so-called Medium styles: having an appearance evoking various mediums/traditional mediums,

Row 3 groups together the so-called Cartoon styles: from the Comic Strip universe,

Row 4 groups together the so-called Folk/cultural styles: faithful to folk, ethnical and cultural traditions,

Row 5 groups together the so-called Trends styles: testimonies to various cultural or historical phenomena

Row 6 groups together the so-called Artistic styles: resulting from various sub-cultures,

Row 7 groups together the so-called Semi-realistic styles: borrowing from realism and conventions, but also involving a more personal vision of the world,

Row 8 groups together the so-called Doodle styles: generated using a spontaneous, impulsive, and more intuitive approach,

Row 9 groups together the so-called Unusual styles: these are novel and not classifiable.

To the right of the family markers such as 1132, each row shows an inventory of the twenty-six genres making up each style family 1100, on the grid 1130. The more a genre, through its marker 1134, is located toward the left of the grid 1130 and, horizontally, is closer to the family marker 1132, the more it has the properties that define the family identified by marker 1132.

A family 1132 or genre 1134 marker presents various information. The upper part of the marker is reserved for the name of the style family. The top right portion of the genre marker 1134 uses a pictogram to show the favored depiction mode for the reproduction of that style genre. The central portion of the family marker 1132 displays the capital letter specific to it. The central portion of the genre marker 1134 is reserved for the acronym specific to the genre. Thus, the first, capital letter is that of the corresponding family and the second, lowercase letter comprised between a and z is determined through the lateral location of the genre on the grid 1130. Accordingly, the letter a is on the far left, and the letter z is located on the far right. Consequently, the lower portion of the family marker 1132 displays the keyword(s) defining the family, while the lower portion of the genre marker 1134 displays the name assigned to the genre.

Lastly, attached to any style genre, a second consultation level has groups of style elements 1134, such as sub-genres. In that figure, the genre marker 1140 is connected to four groups of elements, each presented by a style marker, whereof 1126 is an illustration.

When it reveals style markers, such as 1126, a genre marker such as the marker 1140 shows several pieces of information. The upper portion of the marker is reserved for the serial number of the genre it represents. The right portion uses at least one pictogram to illustrate the favored depiction mode(s) for the reproduction of that style genre. The central portion is reserved for the acronym specific to the genre.

A style marker like the marker 1142 shows several pieces of information. The upper portion is reserved for the code specific to the sub-genre it represents. This alphanumeric code comprises the uppercase and lowercase letter of the genre to which it belongs, a dash and its serial number. To the right of that dash is a number made up of three digits. This number provides more information on the appearance and characteristics of the style shown by the marker 1142. This number thus attests to the vertical position occupied by the style in the grid 1130. In fact, although it is associated with one family, a style can exhibit properties specific to another family. Thus, from the three-digit number, the first digit will be associated with the family/row having the most properties related to the style, excluding the family to which the style already belongs. The central portion of the marker 1142 is reserved for the geometric figures and letters representing the natures of the elements. The shape element is represented by a circle, the line element is illustrated by a diamond, and a square represents the texture element. A textured geometric figure indicates that the element of a corresponding nature can be broken down in that sub-genre. An empty geometric figure indicates the contrary. Lastly, at the bottom of the marker 1142, the pictogram placed across from each geometric figure indicates the favored illustration mode to reproduce the corresponding style element. The lowest portion of the marker 1142 displays the name assigned to the style sub-genre.

The periodic table described above shows, on a second level only, the style elements of all natures combined. It would also be possible to show, from the first level, the elements of each of the three natures in three separate tables.

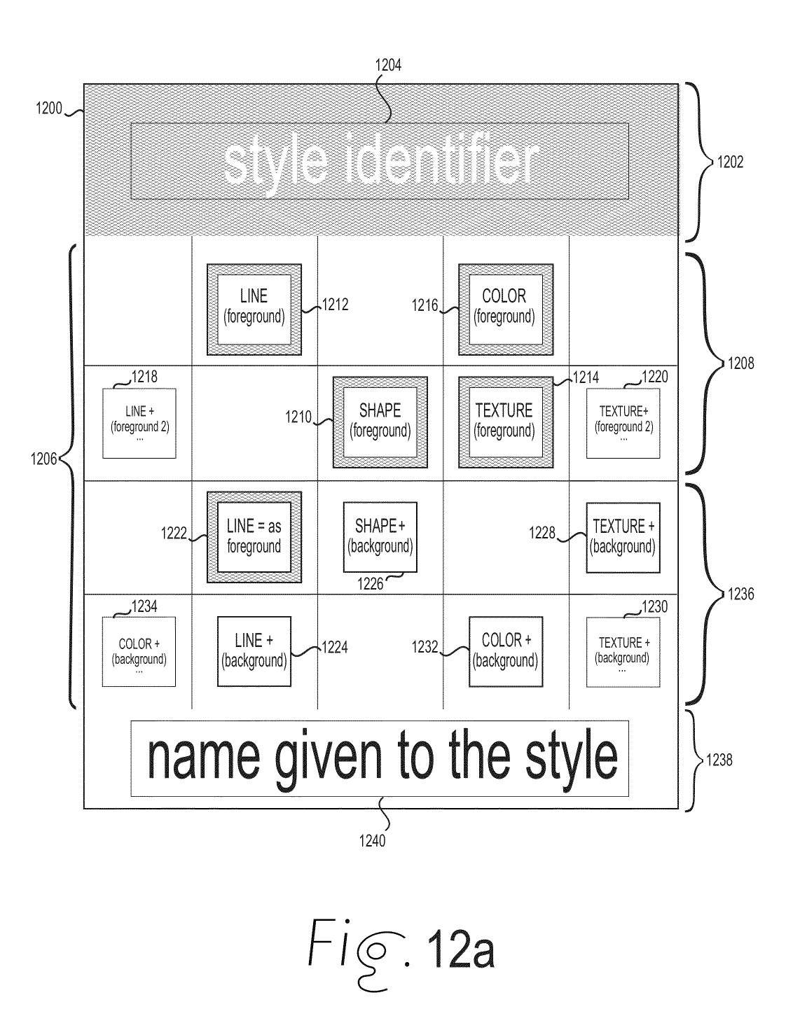

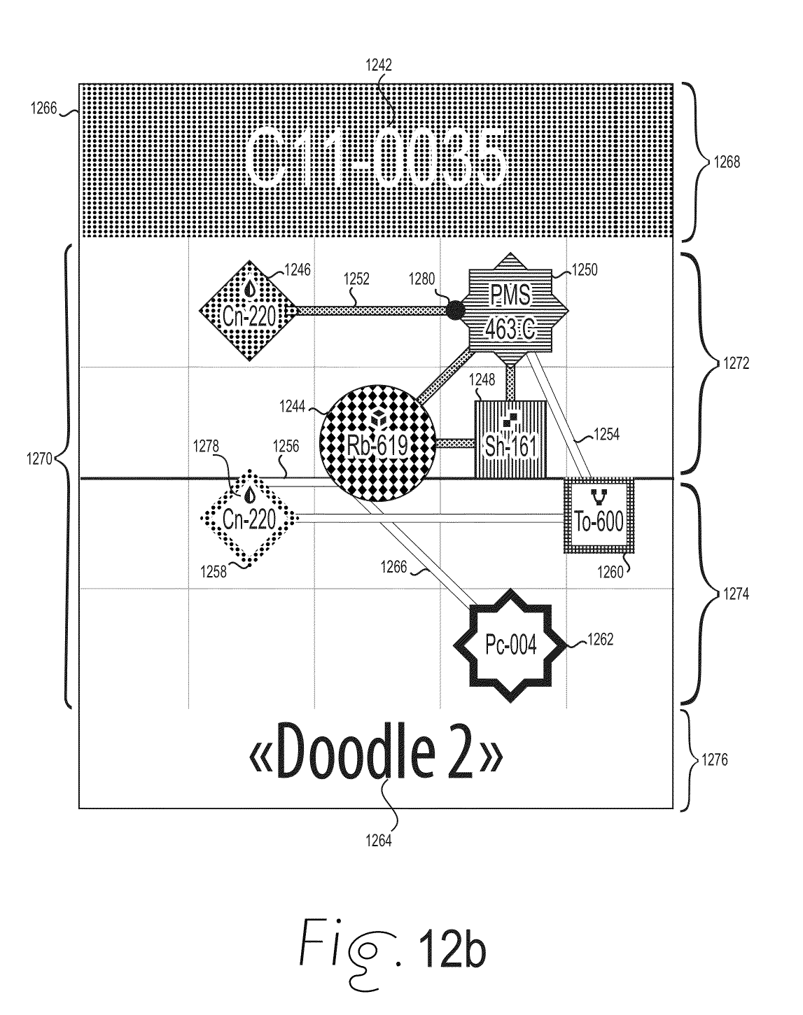

The style elements of the table can be connected to each of their occurrences within molecular style files, according to the structure outlined in FIGS. 12a and 12b.

This table can be shown both physically and virtually.

FIG. 12a: Molecular File Structure of a Style.

Adopting a scheme similar to that of the periodic table, a style element/module can also be modeled in an architecture similar to one of those used to represent the molecules in chemistry. This type of depiction has the advantage of providing a large amount of information in one place. Its graphic standards make it possible to consult a style catalogue or library quickly and efficiently.

The molecular sheet for a style 1200 is structured as follows. The upper portion 1202 shows the assembly identifier 1204 related to that collection. The central portion 1206 is broken down by a grid, divided into two main zones, 1208 and 1236, guiding the arrangement of the various elements. Their location first depends on their nature, then the depth and style planes they will occupy in the illustration.

The upper zone 1208 has the elements illustrating the subject in the foreground. The center of that zone is reserved for any shape element 1210. The left of that zone is reserved for any line elements 1212 and 1218. The bottom right corner of that zone is reserved for any texture elements 1214 and 1220. The upper right corner of that zone is reserved to any color element 1216. The bottom zone 1236 has the elements illustrating the subject in the background. The center of that zone is reserved for any shape element 1226. The portion just to the left is reserved for any line elements 1222 and 1224. The portion just to the right is reserved for any color element 1232. The bottom far left corner of this zone is also for a color element 1234. The right corners of this zone are reserved for any texture elements 1228 and 1230.

The bottom portion of the sheet 1238 bears the name assigned to the module 1240.

Description of FIG. 12b: Example of molecular sheet for a style

In such a sheet, the elements assume various shapes, depending on their nature. A circle if it involves a shape element. A diamond if it involves a line element. A square if it involves a texture element. A star if it involves a color element.

The shapes will also adopt the texture or color associated with the style family from which each of these elements comes.

This molecular sheet for a style 1266 contains the following information. The upper portion 1268 provides the assembly identifier 1242 related to that collection. The central portion 1270, broken down by a grid, provides a large quantity of information.

First, the zone 1272 tells us that the foreground of the illustration will be. Sketched by 3D software, while respecting a high level of realism, in light of the shape element 1244. Drawing of lines and contours from the cartoon genre, revealing that a traditional medium will be textured by matrix image processing software, such as Photoshop, while respecting a semi-realistic, because somewhat refined, appearance, in light of the texture element 1248.

It will also be noted that connections such as 1252 connect certain elements. They show how the elements influence each other. Thus, one can see, inter alio, that: The lines will be black, in light of the point 1280 at the far right of the connection 1252. The texture 1248 will be treated as monochrome, with a Pantone PMS 463C, as attested by the color element 1250.

Like the textured connections 1252, which are specific to the relationships between foreground elements, the non-textured connections 1254 and 1266 only apply their effect to the background elements. There is one exception: if the same shape element is also used in the background, it will benefit from a connection such as 1256, regarding the shapes it will produce for the background.

All of these connections may also be annotated (not shown) to provide information on the relational properties the elements have relative to one another, or on the style figures and semiotic effects that may result from their association.

Next, the zone 1274 tells us that the background of the illustration will be sketched in the same way as the foreground, in light of the absence of a shape element dedicated to that plane. And the same lines drawn in the cartoon genre 1278 for the contours. But these lines will also trim the inside of the shapes 1244 for the background, as indicated by the connection 1256. It will be textured with vectorial drawing software, such as Illustrator, through free use of technical conventions that are usually rigid, thereby generating an artistic texture 1260. This PMS 463C monochrome texture, as indicated by the link 1254, only applies to the lines 1278. In fact, the lack of a connection between the texture element 1260 and the shape element 1244 attests to it. However, as shown by the connection 1266, for lack of texture, the background shapes will be colored taking the color element 1262 into account.

Lastly, the lower portion 1276 shows the name assigned to the module 1264.

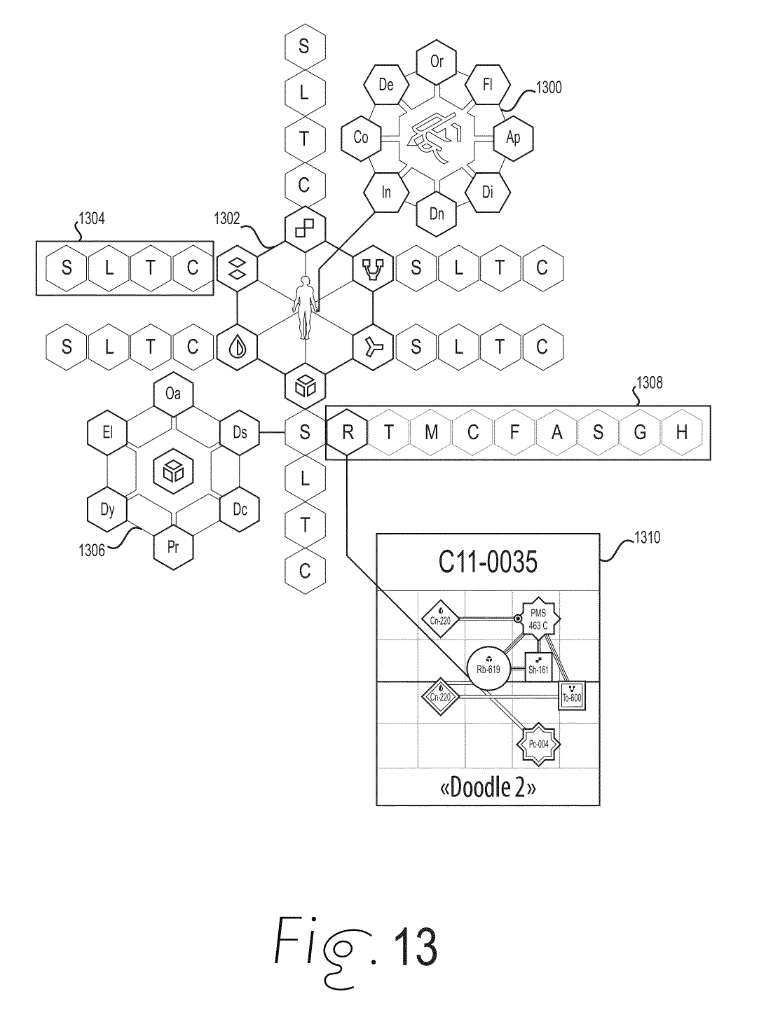

Description of FIG. 13: overview of the components of the model

FIG. 13 provides a summary of several concepts of the present method. Parameters 1300 determining the gesture of a producer are shown, together with an overview of the representation modes 1302 that can master this producer, and for what elements 1304, by nature, the producer can exploit these representation modes 1302. Also, there are the details of an element 1306 with all categories of metadata related thereto, as well as the family, of the nine identified in 1308, to which it belongs. Finally, the molecular form 1310 of a style module in which the producer participates is also shown.

This model offers a concise visual summary of a producer's profile. Note that this figure only shows a first level of information, and that each of the presented dimensions, from 1300 to 1310, could be mined to reveal much more information, for a detailed and precise profile of the producer.

1. A method for producing an order for artwork, comprising:
retrieving a list of producers, said list of producers including a producer identification and at least one style identification for each producer identification;
retrieving availability data for said producers;
receiving a request for artwork from a requester, the request including a requested style identifier and a performance condition;
identifying an available skilled producer among said list of producers, by comparing the performance condition to said availability data and comparing the requested style identifier to the style identification, said at least one style identification of said available skilled producer including said requested style identifier and said availability data of said available skilled producer meeting said performance condition;
generating an order request for artwork to the available skilled producer.

2. The method according to claim 1, further comprising:
retrieving a cost per production unit for said requested style identifier;
receiving an estimation of a number of production units required for the order request, said estimation being prepared using the performance condition;
generating a cost submission for the order request by multiplying the number of production units by the cost per production unit.

3. The method according to claim 1, further comprising:
retrieving a production time per production unit for said requested style identifier;
receiving an estimation of a number of production units required for the order request, said estimation being prepared using the performance condition;
generating a time submission for the order request by multiplying the number of production units by the time per production unit.

4. The method as claimed in claim 3, further comprising determining a multiplying factor using said performance condition and wherein said generating said time submission includes multiplying said multiplying factor by the number of production units and by the time per production unit.

5. The method as claimed in claim 2, further comprising determining a multiplying factor using said performance condition and wherein said generating said cost submission includes multiplying said multiplying factor by the number of production units and by the cost per production unit.

6. The method according to claim 1, further comprising:
Receiving a quotation for said request, said quotation including a description of a subject to be produced connected to the request; and
Assigning said quotation to said order request.

7. The method according to claim 1, wherein the style identification includes at least one independent style element identification, said style element identification representing a style element being chosen from among shape, line, texture, color.

8. The method according to claim 1, further comprising:
Retrieving a plurality of models, each model for a single one of said style identification, said model depicting the style represented by said style identification, the model being artwork produced from a shared generic documentary reference and being a print of the style;
Displaying said models;
Receiving an indication of a chosen model among said models; and
Extracting the style identification corresponding to the chosen model.

9. The method according to claim 1, further comprising:
Retrieving a list of possible styles, said list of possible styles including said style identification and at least one indexed style parameter for each of said styles;
receiving a desired style parameter;
identifying, among the styles of said list of possible styles, a style for which the desired style parameter corresponds to an indexed style parameter;
Extracting the style identification corresponding to the identified style of the desired parameter;
wherein said indexed style parameter is chosen from among the following types of parameters: type of targeted illustrated function, level of realism/proportionality of a style, type of transformation at a root of a level of realism/proportionality of a style, style number, a matrix code, such as QR code, barcode, 2D matrix code, micro QR code, promotional code, price modifier related to a style, form of depiction, family of a style, primary gesture indicator, gesture family, level of compatibility of gestures, genre/sub-genre of a style, production rule, gesture genre/sub-genre, novelty of a style, graphic property, chromatic property such as genre/sub-genre of coloring/palette, depiction parameters related to a subject to be illustrated, relational property, perceptual value evoked, perceptual value related to a style and emotion evoked, with a polarity and intensity value, ambiences evoked, geographic origins evoked, cultural origins evoked, historical origins evoked, artistic movements evoked, artists, artist-specific styles, level of credibility/reputation of a producer/co-producer, affiliation of a producer/co-producer, history of a producer/co-producer, status of a producer/co-producer, resources of a producer/co-producer, area of expertise/experience of a producer/co-producer, quality of a producer/co-producer, determined by: level of punctuality, speed of delivery, efficiency, satisfaction, versatility, information related to collaboration possibilities, professional sector, applied art professional sector, associated technique, associated medium, preference related to a activity sector of a recipient, behavioral model of a target audience, gender of a target audience, socioeconomic profile of a target audience, geographic origin of a target audience, culture or subculture of a target audience, age group of a target audience, type of copyright management for a style, search and order history for a style, identifier for a requester, search and order history for a requester, identifier for a group of a requester, search and order history related to a group of a requester, identifier of a recipient, search and order history for a recipient, identifier of a target audience, search and order history for a target audience, short-term popularity, long-term popularity, short-term appreciation, long-term appreciation, short-term satisfaction level, long-term satisfaction level, quantity of elements of a same module that can be reproduced by a same producer, availability of elements of a same module that can be reproduced by a same producer, quantity of elements of a same module that can be reproduced by different producers, availability of elements of a same module that can be reproduced by different producers, production time, delivery date, anticipated budget, origin of a writer, difficulty coefficient, quantity, availability of a qualified producer/co-producer, origin of a producer/co-producer, region of residence of a producer/co-producer, currency used by a producer/co-producer, cost of living by region, value of a currency, contribution value, type of copyright management for a producer, level of exclusivity required for a image to be produced.

10. The method according to claim 1, wherein the performance condition includes at least one performance data among the following: production time, partial delivery date, final delivery date, anticipated budget, level of detail, type of outline, exclusivity level required for the image that will be produced, for at least one of the producer, co-producer, and production team, experience, skill level, performance, knowledge level by subject, punctuality, history, origin, language, region, rate level of the region, time zone of the region, value of the contribution, responsibility level, type of copyright management.

11. The method according to claim 1, further comprising:
verifying that production rights of the request are appropriate using a list of appropriate production rights.

12. The method according to claim 1, wherein the artwork is at least part of a piece of artwork.

13. The method according to claim 1, wherein style elements are assembled to create a personalized style.

14. The method according to claim 1, further comprising
saving a search history for a requester in the list of styles;
using the history to provide search results to the requester in a subsequent search.

15. The method according to claim 1, wherein the request includes a usage condition for the artwork;
the method further comprising obtaining usage permission data for said producer;
In which the step for identifying an available skilled producer also includes a producer for whom the usage condition corresponds to the permission data.
